(19) United States
(12) Patent Application Publication
(10) Pub. No.: US 2006/0293914 A1
(43) Pub. Date: Dec. 28, 2006

(54) Document management system, client terminal, server, client program and server program

(75) Inventor: Hiroaki Fukuoka, Akita (JP)

Correspondence Address: YOUNG & THOMPSON, 745 SOUTH 23RD STREET, 2ND FLOOR, ARLINGTON, VA, 22202, US

(73) Assignee: NEC LCD TECHNOLOGIES, LTD., KAWASAKI-SHI (JP)

(21) Appl. No.: 11/451,561

(22) Filed: Jun. 13, 2006

(30) Foreign Application Priority Data
Jun. 14, 2005 (JP) 2005-173454

(51) Int. Cl. G06Q 99/00

(52) U.S. Cl. 705/1

(57) ABSTRACT

A user client terminal includes an approval request client to obtain circulation route information indicating a circulation order of circulation objective document data to send the information to a document management server together with the document data and an approval registration client which obtains the document data to present the data to the user and which attains an approval result for the document data to send the result to the server. The server includes a server program which determines whether the circulation order indicated by the circulation route information from the user client terminal conforms to a condition stipulated by an approval flow template and which sends, if the order conforms to the condition, the document data to the user client terminal according to a request. A plurality of circulation target persons are specifiable for one and the same circulation rank. A document management system, a client terminal, a server, a client program, and a server program enable smooth browsing of electronic documents.

### BACKGROUND OF THE INVENTION

1. Field of the Invention

The present invention relates to a document management system to conduct authentication of an electronic document on a network, and in particular, to a document management system to smoothly conduct the document authentication.

2. Description of the Prior Art

In a company or firm, it is required in many cases to circulate a document prepared by an employee through predetermined persons of the firm for approval of each person. This occurs, for example, when rules regarding jobs in the firm are additionally stipulated or are revised.

To enhance the environmental protection of today, paperless jobs have been increasingly introduced to business activities in offices of enterprises. This makes it necessary to circulate electronic documents as well as paper documents.

Japanese Patent Application Laid-Open No. 2002-083103 entitled “Electronic Document Circulation Method, Program, Recording Medium and Electronic Document Circulation System” describes a conventional technique to circulate electronic documents.

According to this article, in an operation to circulate a plurality of electronic documents, all circulation destinations of each electronic document are first obtained and are arranged in a predetermined order to circulate the documents in a circulation route associated with the order of the circulation destinations.

However, the electronic circulation system of the conventional art is able to arrange the circulation destinations only in series. Assume a case in which it is required that, for example, the document is first approved by A and then by B and C to be finally approved by D, and the approval order of B and C is changeable. The circulation route is determined as A→B→C→D or A→C→B→D. In the former situation, if B is busy and cannot immediately carry out the approval, the circulation of the document stops. Even if C can immediately accomplish the approval, C must wait for the appropriate action of B. This also applies to the latter case “A→C→B→D” in which the circulation is interrupted if C cannot carry out the approval.

That is, the conventional circulation system is attended with a problem that the electronic document cannot be smoothly circulated.

### SUMMARY OF THE INVENTION

It is therefore an object of the present invention to provide a document management system, a client terminal, a server, a client program, and a server program capable of smoothly circulate electronic documents.

In accordance with a first mode of the present invention, there is provided a document management system comprising at least one user client terminal and a server connected via a network thereto for circulating document data as an object of circulation through a plurality of users of the client terminal. The user client terminal includes a unit for obtaining circulation route information representing a circulation order of circulation objective document data as an object of circulation, by circulation target persons and circulation ranks; a unit for transmitting the circulation objective document data and the circulation route information to the server, a unit for transmitting a transmission request of the circulation objective document data to the server, a unit for receiving the circulation objective document data from the server, a unit for outputting therefrom the circulation objective document data received from the server, a unit for obtaining an approval result for the circulation objective document data outputted from the output means, and a unit for transmitting the approval result to the server. The server includes a circulation rule information storage having stored therein at least one circulation rule information item indicating a rule to circulate document data, a unit for determining whether the circulation order represented by the circulation route information obtained from the user client terminal conforms to the rule indicated by the circulation rule information stored in the circulation rule information storage, and a unit for transmitting, in response to a request from the user client terminal, the circulation objective document data of which the circulation order is determined to conform to the circulation rule information. A plurality of circulation target persons are specifiable for one and the same circulation rank in the circulation route information.

In accordance with the first mode of the present invention, it is favorable that the user client terminal includes a unit for obtaining a change position of the circulation order of the circulation objective document data, and a unit for notifying the change position of the circulation order to the server. The server includes a unit for obtaining a circulation status of the circulation objective document data for which the change position of the circulation order is notified from the user client terminal, a unit for determining whether the change position of the circulation order notified from the user client terminal changes a circulation target person for whom the circulation objective document data has not been circulated, a unit for determining whether a circulation order after a change of the change position of the circulation order conforms to the rule indicated by the circulation rule information, and a unit for allowing the change of the circulation order if the change position of the circulation order changes a circulation target person for whom the circulation objective document data has not been circulated and the change of the change position conforms to the rule indicated by the circulation rule information.

To achieve the above object in accordance with a second mode of the present invention, there is provided a document management system including at least one user client terminal and a server connected via a network thereto for circulating document data as an object of circulation through a plurality of users of the client terminal. The user client terminal includes a unit for obtaining circulation route information representing a circulation order of circulation objective document data as an object of circulation, by circulation target persons and circulation ranks; a unit for transmitting the circulation objective document data and the circulation route information to the server, a unit for transmitting a transmission request of the circulation objective document data to the server, a unit for receiving the circulation objective document data from the server, a unit for outputting therefrom the circulation objective document data received from the server, a unit for obtaining an approval result for the circulation objective document data outputted from the output means, and a unit for transmitting the approval result to the server, a unit for obtaining, through an operation by the user, a change position of the circulation order of circulation objective document data for which the user of the own terminal is a requester, and a unit for notifying the change position of the circulation order to the server. The server includes a circulation rule information storage having stored therein at least one circulation rule information item indicating a rule to circulate document data, a unit for determining whether the circulation order represented by the circulation route information obtained from the user client terminal conforms to the rule indicated by the circulation rule information stored in the circulation rule information storage, a unit for transmitting, in response to a request from the user client terminal, the circulation objective document data of which the circulation order is determined to conform to the circulation rule information, a unit for obtaining a circulation status of the circulation objective document data of which the change position of the circulation order is notified from the user client terminal, a unit for determining whether the change position of the circulation order changes a circulation target person for whom the circulation objective document data has not been circulated, a unit for determining whether a circulation order after a change of the change position of the circulation order conforms to the rule indicated by the circulation rule information, and a unit for allowing the change of the circulation order if the change position of the circulation order changes a circulation target person for whom the circulation objective document data has not been circulated and the change of the change position conforms to the rule indicated by the circulation rule information.

In accordance with the second mode of the present invention, it is desirable that a plurality of circulation target persons are specifiable for one and the same circulation rank in the circulation route information.

In the structure of the first and second modes of the present invention, it is favorable that the server includes a unit for conducting notification after the circulation of the circulation objective document data is completely conducted by a circulation target person of a particular circulation rank, if the circulation has not been completely conducted for a circulation target person of a subsequent circulation rank during a predetermined period of time, the notification notifying a lapse of the predetermined period of time to a circulation target person for whom the circulation objective document data has not been circulated. It is also desirable that after the circulation of the circulation objective document data is completely conducted by a circulation target person of a particular circulation rank, if the circulation has not been completely conducted for a circulation target person of a subsequent circulation rank during a predetermined period of time and if a proxy circulation target person is beforehand registered to the circulation objective document data, the server changes the circulation order by setting the proxy circulation target person as a formal circulation target person.

In both configurations of the first and second modes of the present invention, it is desirable that the user client terminal includes a unit for obtaining as circulation scheduled document data from the server, circulation objective document data for which the user of the own terminal is designated as a circulation target person and the person waiting for her or his turn for circulation of the document data, and a unit for outputting therefrom the circulation scheduled document data. It is also favorable that the user client terminal includes a unit for obtaining an approval result for the circulation scheduled document data, and a unit for transmitting the approval result to the server. The server confirms, at completion of the circulation by the circulation target person of a particular circulation rank, whether an approval result for the circulation scheduled document data by a circulation target person of a subsequent circulation rank has been registered, and assumes the approval result as an approval result of the circulation objective document data if the approval result has been registered.

In the configurations of the first and second modes of the present invention, it is desirable that the document management system further includes a unit for converting, when the circulation objective document data includes data groups of mutually different two or more file formats, the file formats into one particular file format and combining the data groups with each other into one data group. It is desirable that the document management system further includes a unit for notifying, at completion of the circulation of the circulation objective document data by a circulation target person of a lowest circulation rank, completion of the circulation objective document data to a predetermined user. In addition, it is favorable that the document management system further includes a unit for notifying, if the authentication result of the circulation objective document data of a particular circulation rank is rejection, the rejection of the circulation objective document data to the circulation requester of the circulation objective document data and circulation target persons of a circulation rank higher than the circulation rank associated with the rejection.

To achieve the above object in accordance with a third mode of the present invention, there is provided a document management system including at least one user client terminal, a manager client terminal, a server, and a database connected via a network to each other for circulating document data as an object of circulation through a plurality of users of the client terminal. The user client terminal includes a unit for obtaining circulation route information representing a circulation order of circulation objective document data as an object of circulation, by circulation target persons and circulation ranks; a unit for transmitting the circulation objective document data and the circulation route information to the server, a unit for transmitting a transmission request of the circulation objective document data to the server, a unit for receiving the circulation objective document data from the server, a unit for outputting therefrom the circulation objective document data received from the server, a unit for obtaining an approval result for the circulation objective document data outputted from the output means, and a unit for transmitting the approval result to the server. The database includes a circulation rule information storage having stored therein at least one circulation rule information item indicating a rule to circulate document data, a during-approval document information storage for storing therein during-approval document information indicating a status of a document file in circulation, and a formal document information storage for storing therein formal document information indicating a status of a document file for which the circulation has been completed. The server includes a unit for obtaining, from the database, the circulation rule information according to the circulation route information obtained from the user client terminal; a unit for determining whether the circulation order represented by the circulation route information obtained from the user client terminal conforms to the rule indicated by the circulation rule information obtained from the database, and a unit for transmitting, in response to a request from the user client terminal, the circulation objective document data of which the circulation order is determined to conform to the circulation rule information, a plurality of circulation target persons being specifiable for one and the same circulation rank.

In order to achieve the object, there is provided in accordance with a fourth mode of the present invention, there is provided a client terminal including a unit for communicating information via a network with a server, a unit for obtaining circulation route information representing a circulation order of circulation objective document data as an object of circulation, by circulation target persons and circulation ranks; a unit for transmitting the circulation objective document data and the circulation route information to the server, a unit for transmitting a transmission request of the circulation objective document data to the server, a unit for receiving the circulation objective document data from the server, a unit for outputting therefrom the circulation objective document data received from the server, a unit for obtaining an approval result for the circulation objective document data outputted from the output unit, and a unit for transmitting the approval result to the server, a plurality of circulation target persons being specifiable for one and the same circulation rank in the circulation route information.

It is favorable in the fourth mode that the client terminal further includes a unit for obtaining a change position of the circulation order of the circulation objective document data, and a unit for notifying the change position of the circulation order to the server.

To achieve the above object, there is provided in accordance with a fifth mode of the present invention a client terminal including a unit for communicating information via a network with a server, a unit for obtaining circulation route information representing a circulation order of circulation objective document data as an object of circulation, by circulation target persons and circulation ranks; a unit for transmitting the circulation objective document data and the circulation route information to the server, a unit for transmitting a transmission request of the circulation objective document data to the server, a unit for receiving the circulation objective document data from the server, a unit for outputting therefrom the circulation objective document data received from the server, a unit for obtaining an approval result for the circulation objective document data outputted from the output means, a unit for transmitting the approval result to the server, a unit for obtaining a change position of the circulation order of the circulation objective document data, and a unit for notifying the change position of the circulation order to the server.

In the fifth mode of the present invention, it is favorable that a plurality of circulation target persons are specifiable for one and the same circulation rank in the circulation route information.

It is desirable in the configurations of the fourth and fifth modes that the client terminal includes a unit for obtaining as circulation scheduled document data from the server, circulation objective document data for which the user of the own terminal is designated as a circulation target person and the person waiting for her or his turn for circulation of the document data, and a unit for outputting therefrom the circulation scheduled document data. Additionally, it is favorable that the client terminal includes a unit for obtaining an approval result for the circulation scheduled document data, and a unit for transmitting the approval result to the server.

In order to achieve the above object in accordance with a sixth mode of the present invention, there is provided a server connected via a network to at least one user client terminal. The server includes a circulation rule information storage having stored therein at least one circulation rule information item indicating a rule to circulate document data, a unit for obtaining, from the user client terminal, circulation route information representing a circulation order of circulation objective document data as an object of circulation, by circulation target persons and circulation ranks; a unit for determining whether the circulation order represented by the circulation route information obtained from the user client terminal conforms to the rule indicated by the circulation rule information stored in the circulation rule information storage, and a unit for transmitting, in response to a request from the user client terminal, the circulation objective document data of which the circulation order is determined to conform to the circulation rule information, a plurality of circulation target persons being specifiable for one and the same circulation rank in the circulation route information.

In the sixth mode in accordance with the present invention, it is favorable that the server includes a unit for obtaining a change position of the circulation order of the circulation objective document data from each of the user client terminals, a unit for obtaining a circulation status of the circulation objective document data for which the change position of the circulation order is obtained from the user client terminal, a unit for determining whether the change position of the circulation order obtained from the user client terminal changes a circulation target person for whom the circulation objective document data has not been circulated, a unit for determining whether a circulation order after a change of the change position of the circulation order conforms to the rule indicated by the circulation rule information, and a unit for allowing the change of the circulation order if the change position of the circulation order changes a circulation target person for whom the circulation objective document data has not been circulated and the change of the change position conforms to the rule indicated by the circulation rule information.

To achieve the object in accordance with a seventh mode of the present invention, there is provided a server connected via a network to at least one user client terminal. The server includes a circulation rule information storage having stored therein at least one circulation rule information item indicating a rule to circulate document data, a unit for obtaining, from the user client terminal, circulation route information representing a circulation order of circulation objective document data as an object of circulation, by circulation target persons and circulation ranks; a unit for determining whether the circulation order represented by the circulation route information obtained from the user client terminal conforms to the rule indicated by the circulation rule information stored in the circulation rule information storage means, a unit for transmitting, in response to a request from the user client terminal, the circulation objective document data of which the circulation order is determined to conform to the circulation rule information; a unit for obtaining a circulation status of the circulation objective document data for which the change position of the circulation order is notified from the user client terminal, a unit for determining whether the change position of the circulation order notified from the user client terminal changes a circulation target person for whom the circulation objective document data has not been circulated, a unit for determining whether a circulation order after a change of the change position of the circulation order conforms to the rule indicated by the circulation rule information, and a unit for allowing the change of the circulation order if the change position of the circulation order changes a circulation target person for whom the circulation objective document data has not been circulated and the change of the change position conforms to the rule indicated by the circulation rule information.

In the seventh mode of the present invention, it is desirable that a plurality of circulation target persons are specifiable for one and the same circulation rank in the circulation route information.

In the structure of the six and seventh modes of the present invention, it is favorable that the server includes a unit for conducting notification after the circulation of the circulation objective document data is completely conducted by a circulation target person of a particular circulation rank, if the circulation has not been completely conducted for a circulation target person of a subsequent circulation rank during a predetermined period of time, the notification notifying a lapse of the predetermined period of time to a circulation target person for whom the circulation objective document data has not been circulated.

In the structure of the sixth and seventh modes of the present invention, it is favorable that after the circulation of the circulation objective document data is completely conducted by a circulation target person of a particular circulation rank, if the circulation has not been completely conducted for a circulation target person of a subsequent circulation rank during a predetermined period of time and if a proxy circulation target person is beforehand registered to the circulation objective document data, the server changes the circulation order by setting the proxy circulation target person as a formal circulation target person. Furthermore, the server includes a unit for transmitting as circulation scheduled document data, in response to a request from the user client terminal, circulation objective document data for which the user of the user client terminal as a request source is designated as a circulation target person and the person waiting for her or his turn for circulation of the document data, to the user client terminal as a request source; a unit for obtaining an approval result for the circulation scheduled document data from the user client terminal, and a unit for confirming, at completion of the circulation by the circulation target person of a particular circulation rank, whether an approval result for the circulation scheduled document data by a circulation target person of a subsequent circulation rank has been registered, and assuming the approval result as an approval result of the circulation objective document data if the approval result has been registered.

In order to achieve the above object in accordance with an eighth mode of the present invention, there is provided a client program for making a computer controlling a client terminal having a function to communicate information with a server connected via a network thereto function as a unit for obtaining circulation route information representing a circulation order of circulation objective document data as an object of circulation, by circulation target persons and circulation ranks, a unit for transmitting the circulation objective document data and the circulation route information to the server; a unit for transmitting a transmission request of the circulation objective document data to the server, a unit for receiving the circulation objective document data from the server, a unit for outputting therefrom the circulation objective document data received from the server, a unit for obtaining an approval result for the circulation objective document data outputted from the output means, and a unit for transmitting the approval result to the server, a plurality of circulation target persons being specifiable for one and the same circulation rank in the circulation route information.

In the eighth mode of the present invention, it is favorable that the client program makes the computer function as a unit for obtaining a change position of the circulation order of the circulation objective document data, and a unit for notifying the change position of the circulation order to the server.

To achieve the object described above, there is provided a client program in accordance with a ninth mode of the present invention for making a computer controlling a client terminal having a function to communicate information with a server connected via a network thereto function as a unit for obtaining circulation route information representing a circulation order of circulation objective document data as an object of circulation, by circulation target persons and circulation ranks; a unit for transmitting the circulation objective document data and the circulation route information to the server, a unit for transmitting a transmission request of the circulation objective document data to the server, a unit for receiving the circulation objective document data from the server, a unit for outputting therefrom the circulation objective document data received from the server, a unit for obtaining an approval result for the circulation objective document data outputted from the output means, a unit transmitting the approval result to the server, a unit for obtaining a change position of the circulation order of the circulation objective document data, and a unit for notifying the change position of the circulation order to the server.

In the ninth mode of the present invention, it is favorable in the client program that a plurality of circulation target persons are specifiable for one and the same circulation rank in the circulation route information.

In the configurations of the eighth and ninth modes of the present invention, it is desirable that the client program makes the computer function as a unit for obtaining as circulation scheduled document data from the server, circulation objective document data for which the user of the own terminal is designated as a circulation target person and the person waiting for her or his turn for circulation of the document data, and a unit for outputting therefrom the circulation scheduled document data. It is more desirable that the program makes the computer function as a unit for obtaining an approval result for the circulation scheduled document data, and a unit for transmitting the approval result to the server.

To achieve the object in accordance with a tenth mode of the present invention, there is provided a server program for making a computer controlling a server connected via a network to at least one user client terminal function as a circulation rule information storage having stored therein at least one circulation rule information item indicating a rule to circulate document data, a unit for obtaining, from the user client terminal, circulation route information representing a circulation order of circulation objective document data as an object of circulation, by circulation target persons and circulation ranks; a unit for determining whether the circulation order represented by the circulation route information obtained from the user client terminal conforms to the rule indicated by the circulation rule information stored in the circulation rule information storage means, and a unit for transmitting, in response to a request from the user client terminal, the circulation objective document data of which the circulation order is determined to conform to the circulation rule information, a plurality of circulation target persons being specifiable for one and the same circulation rank in the circulation route information.

In the tenth mode of the present invention, the server program favorably makes the computer function as a unit for obtaining a change position of the circulation order of the circulation objective document data from each of the user client terminals, a unit for obtaining a circulation status of the circulation objective document data for which the change position of the circulation order is obtained from the user client terminal, a unit for determining whether the change position of the circulation order obtained from the user client terminal changes a circulation target person for whom, the circulation objective document data has not been circulated, a unit for determining whether a circulation order after a change of the change position of the circulation order conforms to the rule indicated by the circulation rule information, and a unit for allowing the change of the circulation order if the change position of the circulation order changes a circulation target person for whom the circulation objective document data has not been circulated and the change of the change position conforms to the rule indicated by the circulation rule information.

In order to achieve the above object in accordance with an 11th mode of the present invention, there is provided a server program for making a computer controlling a server connected via a network to at least one user client terminal function as a circulation rule information storage having stored therein at least one circulation rule information item indicating a rule to circulate document data, a unit for obtaining, from the user client terminal, circulation route information representing a circulation order of circulation objective document data as an object of circulation, by circulation target persons and circulation ranks; a unit for determining whether the circulation order represented by the circulation route information obtained from the user client terminal conforms to the rule indicated by the circulation rule information stored in the circulation rule information storage means, a unit for transmitting, in response to a request from the user client terminal, the circulation objective document data of which the circulation order is determined to conform to the circulation rule information; a unit for obtaining a circulation status of the circulation objective document data for which the change position of the circulation order is notified from the user client terminal, a unit for determining whether the change position of the circulation order notified from the user client terminal changes a circulation target person for whom the circulation objective document data has not been circulated, a unit for determining whether a circulation order after a change of the change position of the circulation order conforms to the rule indicated by the circulation rule information, and a unit for allowing the change of the circulation order if the change position of the circulation order changes a circulation target person for whom the circulation objective document data has not been circulated and the change of the change position conforms to the rule indicated by the circulation rule information.

In the 11th mode of the present invention, it is favorable that a plurality of circulation target persons are specifiable for one and the same circulation rank in the circulation route information.

In the structure of the 10th and 11th modes of the present invention, the server program desirably makes the computer function as a unit for conducting notification after the circulation of the circulation objective document data is completely conducted by a circulation target person of a particular circulation rank, if the circulation has not been completely conducted for a circulation target person of a subsequent circulation rank during a predetermined period of time, the notification notifying a lapse of the predetermined period of time to a circulation target person for whom the circulation objective document data has not been circulated.

Also, in the structure of the 10th and 11th modes of the present invention, it is desirable that the program makes the computer make a change after the circulation of the circulation objective document data is completely conducted by a circulation target person of a particular circulation rank, if the circulation has not been completely conducted for a circulation target person of a subsequent circulation rank during a predetermined period of time and if a proxy circulation target person is beforehand registered to the circulation objective document data, the change changing the circulation order by setting the proxy circulation target person as a formal circulation target person. It is also favorable that the server program makes the computer function as a unit for transmitting as circulation scheduled document data, in response to a request from the user client terminal, circulation objective document data for which the user of the user client terminal as a request source is designated as a circulation target person and the person waiting for her or his turn for circulation of the document data, to the user client terminal as a request source; a unit for obtaining an approval result for the circulation scheduled document data from the user client terminal, and a unit for confirming, at completion of the circulation by the circulation target person of a particular circulation rank, whether an approval result for the circulation scheduled document data by a circulation target person of a subsequent circulation rank has been registered, and assuming the approval result as an approval result of the circulation objective document data if the approval result has been registered.

In accordance with the present invention, there is provided a document management system, a client terminal, a server, a client program, and a server program in which electronic documents can be smoothly browsed.

### BRIEF DESCRIPTION OF THE DRAWINGS

The objects and features of the present invention will become more apparent from the consideration of the following detailed description taken in conjunction with the accompanying drawings in which:

FIG. 1 is a schematic block diagram showing a configuration of a first embodiment of an electronic document circulation system;

FIG. 2 is a diagram showing data layouts of information of the during-approval document information;

FIG. 3 is a diagram showing data layouts of information of the formal document information;

FIG. 4 is a diagram showing data layouts of master information;

FIG. 5 is a diagram showing examples of approval flow templates;

FIG. 6 is a flow diagram showing mail transmission processing by a mail transmission client;

FIG. 7 is a flowchart showing a flow of operation of authentication request processing;

FIG. 8 is a block diagram showing upload processing to upload an approval target document from a user client terminal to a document management server;

FIG. 9 is a diagram showing an example of a document symbol master;

FIG. 10 is a flowchart showing operation of document conversion processing;

FIG. 11 is a diagram showing an example of operation of document conversion processing;

FIG. 12 is a flowchart showing operation for document approval and registration;

FIG. 13 is a flowchart showing operation of document issuance processing;

FIG. 14 is a flowchart showing operation of time-expired document invalidation processing;

FIG. 15 is a flowchart showing operation of approval flow change processing;

FIG. 16 is a flowchart showing a flow of operation in the approval flow change processing;

FIG. 17 is a diagram to explain an example of the approval flow change processing;

FIG. 18 is a flowchart showing a flow of operation in the reserved approval processing;

FIG. 19 is a flowchart showing an operation flow of the reserved approval processing; and

FIG. 20 is a flowchart showing a flow of operation in the approver change processing.

### DESCRIPTION OF THE EMBODIMENTS

### First Embodiment

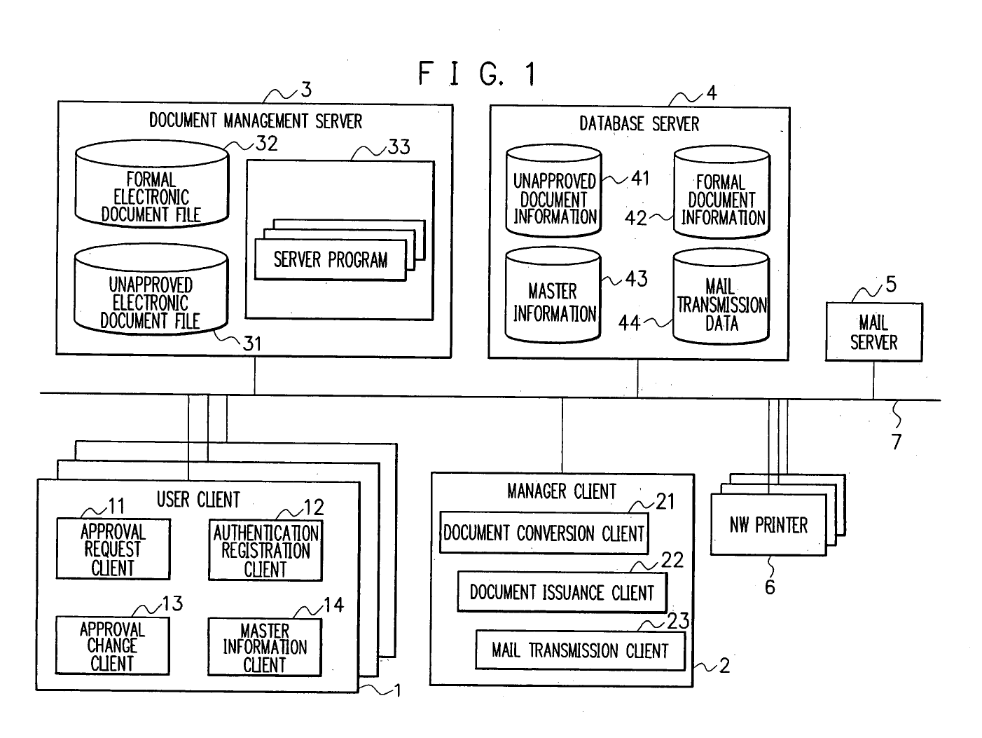

Description will now be given of the first embodiment in accordance with the present invention. FIG. 1 shows structure of the first embodiment of an electronic document circulation system. The system includes user client terminals 1, a manager client terminal 2, a document management server 3, a database (DBS) 4, a mail server 5, network (NW) printer 6, and a network 7 connecting the constituent components to each other. Each of the terminals and the servers includes a function to communicate data via the network 7. The network printer 6 includes a function to receive data via the network 7.

A user client terminal 1 includes an approval request client 11, an approval registration client 12, an approval change client 13, and a master information client 14. When a Central Processing Unit (CPU), not shown, of the user client terminal 1 executes an application program using a Random Access Memory (RAM), not shown, as a work area, the clients 11 to 14 are implemented on the CPU.

The approval request client 11 is a client for a user to request approval of a document. The approval registration client 12 is a client for a user having received a request for approval from another person to approve a document. The approval change client 13 is a client for a user having requested approval of a document to change an approval flow. The master information client 14 is a client to change master information registered to the database server 4 or to register a new entry thereto.

Operation of these clients will be described later.

The manager client terminal 2 includes a document conversion client 21, a document issuance client 22, and a mail transmission client 23. To implement the clients 21 to 23, the CPU of the manager client terminal 1 executes an application program using an RAM (not shown) as a work area.

The conversion client 21 converts data of a document requested for approval by the approval request client 11 into a predetermined file format. For an approved document, the document issuance client 22 executes processing to register or to deliver the document as a formal document. The mail transmission client 23 conducts operation to notify by electronic mail, i.e., e-mail, a history and a result of the approval process.

The document management server 3 includes an unapproved electronic document file storage section 31, a formal electronic document file storage section 32, and a server program 33.

The file storage section 31 stores therein data of a file requested by the user client 1 for approval. The formal electronic document file storage section 32 is used to store data of a document approved through the approval procedure. The server program 33 includes server-side program groups respectively corresponding to the clients included in the user and manager client terminals 1 and 2, specifically, the approval request client 11, the approval registration client 12, the approval change client 13, the master information client 14, the document conversion client 21, the document issuance client 22, and the mail transmission client 23. The programs operate in cooperation with the respective clients to respectively achieve predetermined operations. For implementation of the server program 33, the document management server 3 executes by a CPU (not shown) an application program using an RAM (not shown) as a work area.

The database server 4 includes an unapproved document information storage section 41, a formal document information storage section 42, a master information storage section 43, and a mail transmission data storage section 44.

The storage section 41 stores bibliographical information of an unapproved document. The formal document information storage section 42 is disposed to store bibliographical information of a document that has been approved. The master information storage section 43 stores information regarding definitions required to approve a document. The mail transmission data storage section 44 is used to store data that the mail transmission client 23 delivers by e-mail.

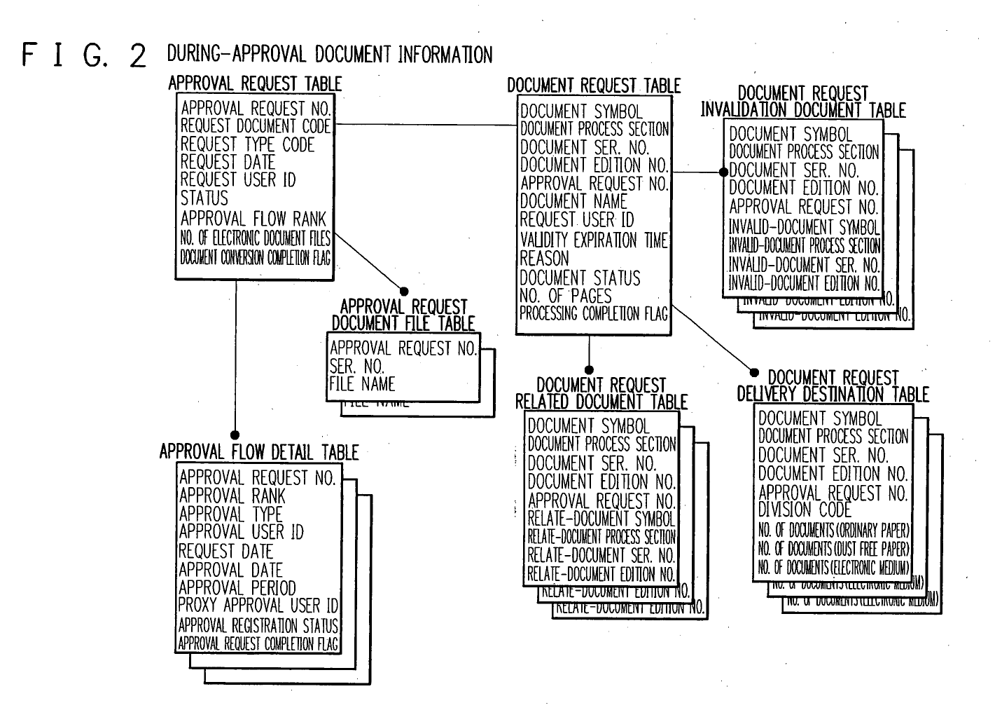

FIG. 2 shows data layouts of unapproved document information. The information includes an approval request table, an approval flow detail table, an approval request document file table, a document request table, a document request related document table, a document request invalidation document table, and a document request delivery destination table.

The approval request table includes information to identify a document to be approved and a status of the document. The approval flow detail table includes an authenticator and a processing status for each approval flow stage. The approval request document file table includes constituent files of the document to be approved. The document request table is used to indicate a state of the document to be approved. The document request related document table identifies other documents related to the document to be approved. The document request invalidation document table is adopted to identify a document when the document to be approved is issued. The document request delivery destination table includes information indicating, at issuance of the document to be approved, a destination and a document volume of the delivery as well as how to deliver the volume.

In this regard, the approval flow detail table, the approval request document file table, and the document request table include information associated with the approval request table. The document request related document table, the document request invalidation document table, and the document request delivery destination table store information belonging to the document request table.

The document request related table and the document invalidation document table exist only if a related document and an invalidation designation document are present for the document to be approved.

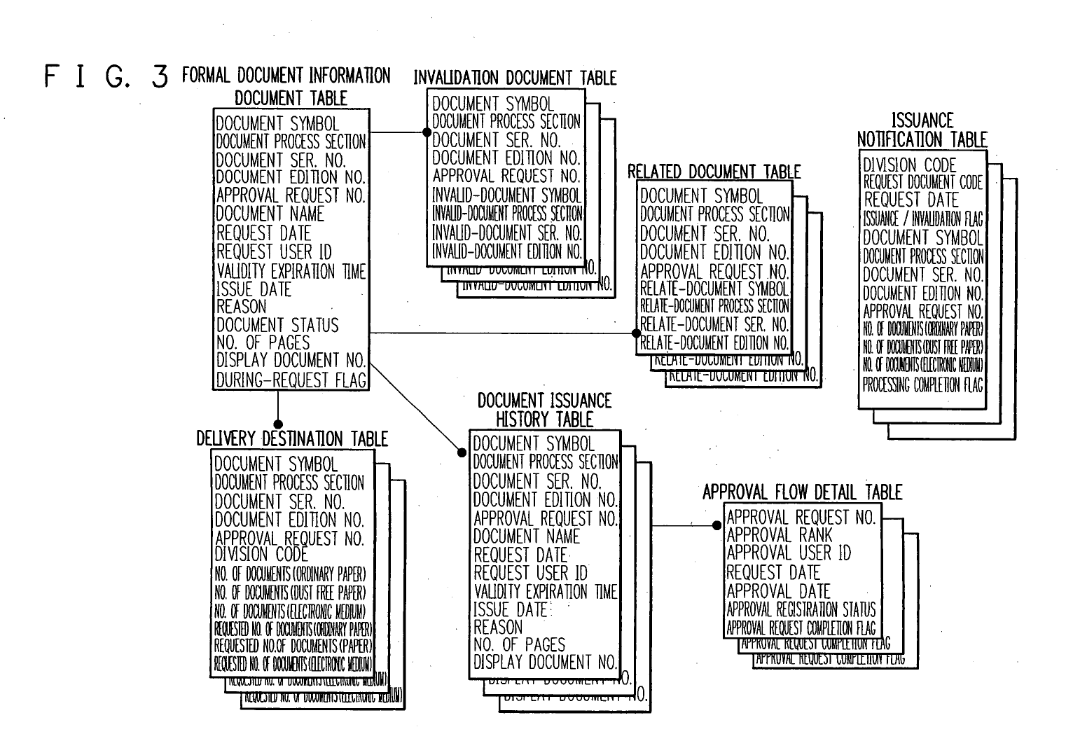

FIG. 3 shows data layouts of formal document information. The information includes a document table, a delivery destination table, an invalidation document table, a document issuance history table, a related document table, an approval flow detail table, and an issuance notification table.

The document table includes information to identify a document and a status thereof. The delivery destination table indicates a destination and a document volume of the delivery as well as how to deliver the document. The invalidation document table is disposed to identify a document invalidated at occurrence of the document under consideration. The document issuance history table indicates a history from document issuance to the current point of time. The approval flow detail table is used to keep information indicating an approval flow conducted for the issuance of the document. The related document table includes information to identify a document registered as a related document. The issuance notification table; is employed to discriminate document issuance from document, invalidation. For document issuance and invalidation, the table indicates a delivery destination and a document volume.

Incidentally, the approval flow detail information is data accompanying the document issuance history information. The delivery destination information, the invalidation document information, and the related document information include data belonging to the document information.

Only if a related document and an invalidation designation document have been registered before issuance of an approval request, there exist a related document table and an invalidation table.

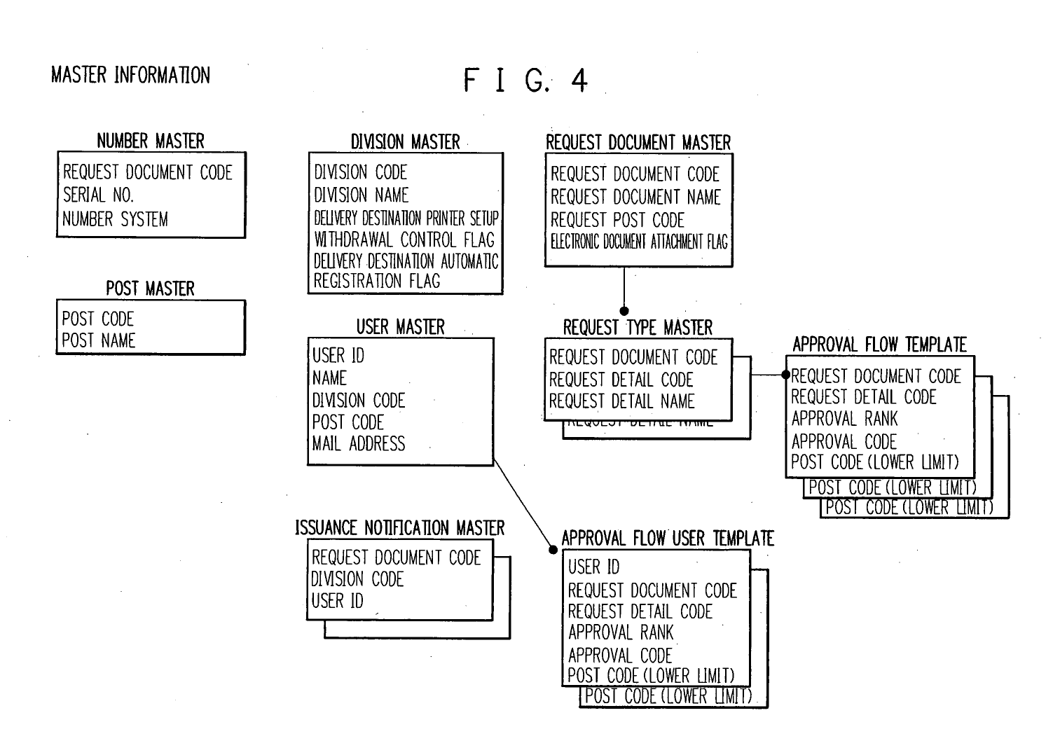

FIG. 4 shows data layout examples of master information stored in the master information storage section 43.

The master information includes a number master, a post master, a division master, a user master, an issuance notification master, a request document master, a request type master, an approval flow template, and an approval flow user template. The master information represents data layouts of information required to execute authentication processing.

The number master includes a data layout of information adopted to assign a request number to a document as an object of approval. The post master indicates a data layout of information expressing a correspondence between a post code and a post name. The division master includes a data layout of information denoting a correspondence between a division code and a division name and a delivery destination printer. The user master is disposed to indicate a data layout of personal information of each user. The issuance notification master is data structure of information indicating a destination, i.e., a division and a person, of a document at issuance thereof. The request document master includes a data layout of information to indicate a document for which an approval request has been issued. The request type master is structure of data of information indicating a request type with which an associated approval request has been issued. The approval flow template denotes a data layout of information to indicate a type (e.g., inspection, approval, or consultation) of authentication for any request document, any request type, and any request rank and a lowest post with authority for the authentication.

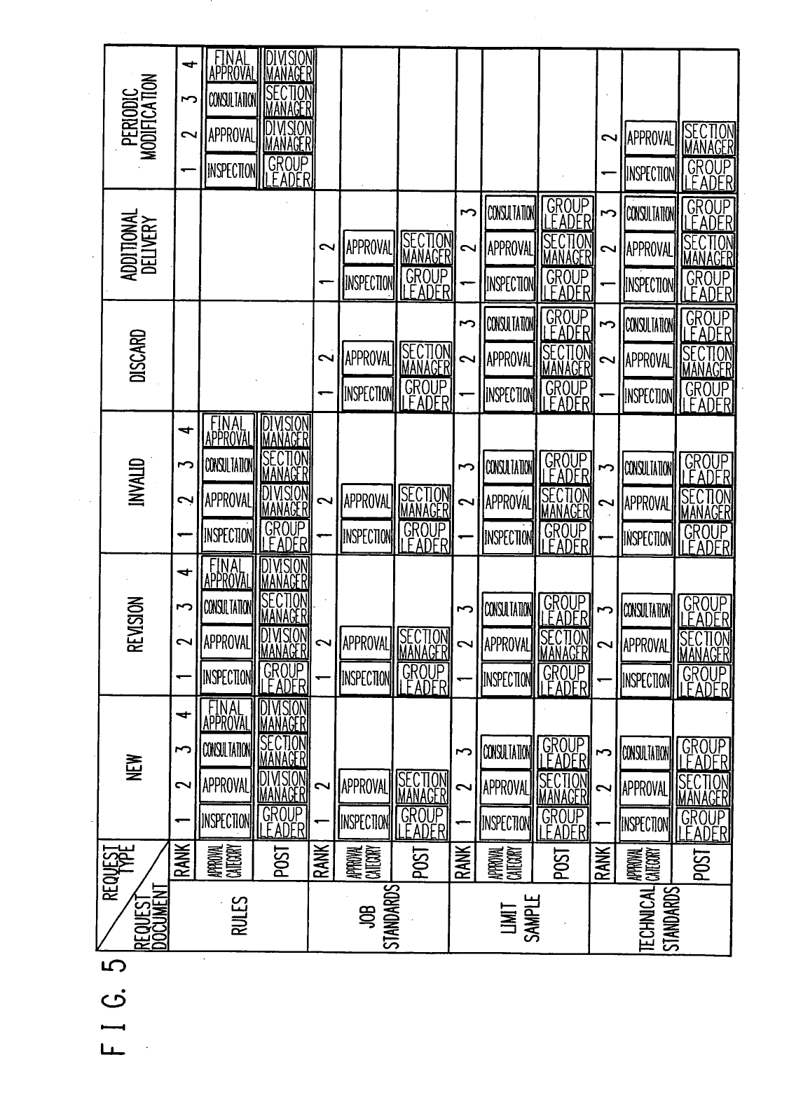

FIG. 5 shows a specific example of the approval flow template. The template can be classified in a matrix shape according to a request document and a request type. Assume that “rule” and “new” are selected as a request document and a request type respectively. To issue the document, inspection is to be carried out by a person of a post equal to or higher than a group leader, and then approval of the document is to be given by a person at a post equal to or higher than a division manager. Thereafter, consultation for the document by persons at a post equal to or higher than a section manager follows and then final approval by a person at a post equal to or higher than a division manager is conducted.

In the system, a plurality of clients and a plurality of server programs are capable of creating e-mail data. E-mail data items produced from the clients and the server programs are stored in the mail transmission data storage section 44 of the database server 4. The mail data is actually transmitted from the storage section 44 in the processing of the mail transmission client 23.

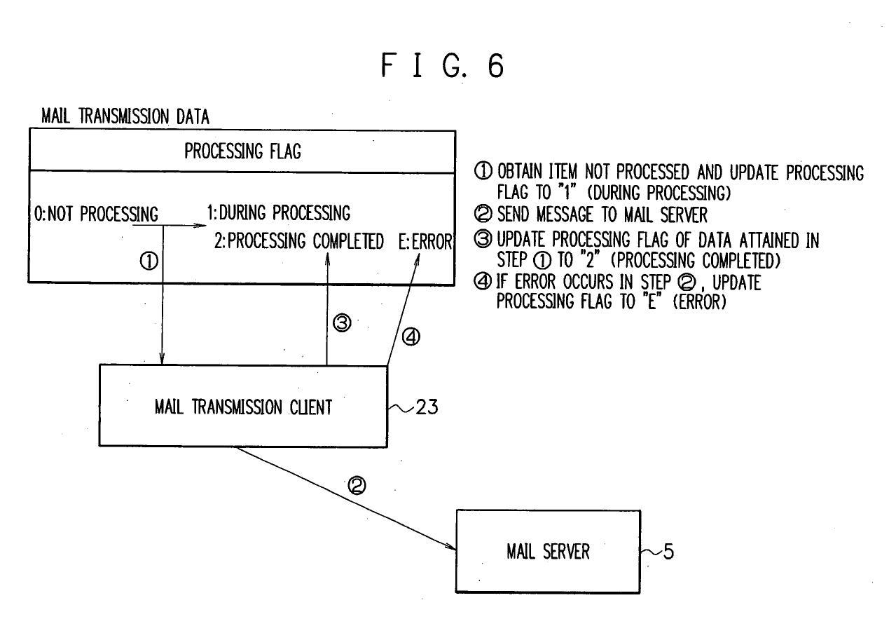

The operation to transmit a mail piece is described by referring to FIG. 6. The mail transmission client 23 reads at activation thereof a setup file to acquire information items such as a processing interval time, a mail server address, and a mail transmission address to be used at occurrence of an error. The client 23 obtains mail transmission data to be processed, i.e., data having a processing flag set to “0” and then updates the flag to “1” indicating “in processing”. The client 23 then actually executes the transmission processing to send the data to the mail server and updates the flag to “2” indicating “processing completed”. The processing is repeatedly executed at every predetermined period of time (interval time). If an error, e.g., a halt of operation of the mail server or a mail address error occurs during the processing, the client 23 notifies an error to the mail transmission address for occurrence of an error and then set the document status to “E” indicating an error.

Description will now be given of operation in the embodiment of an electronic document circulation system.

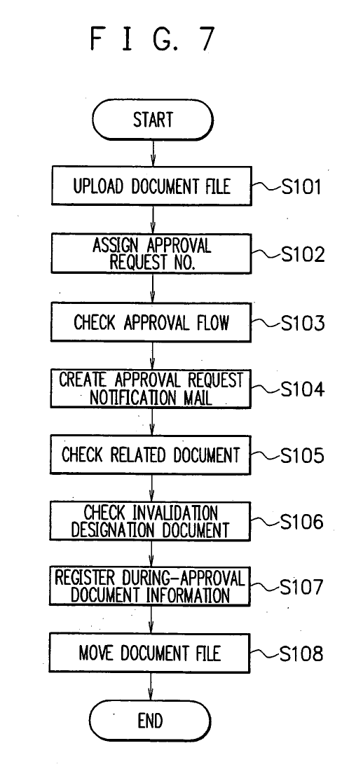

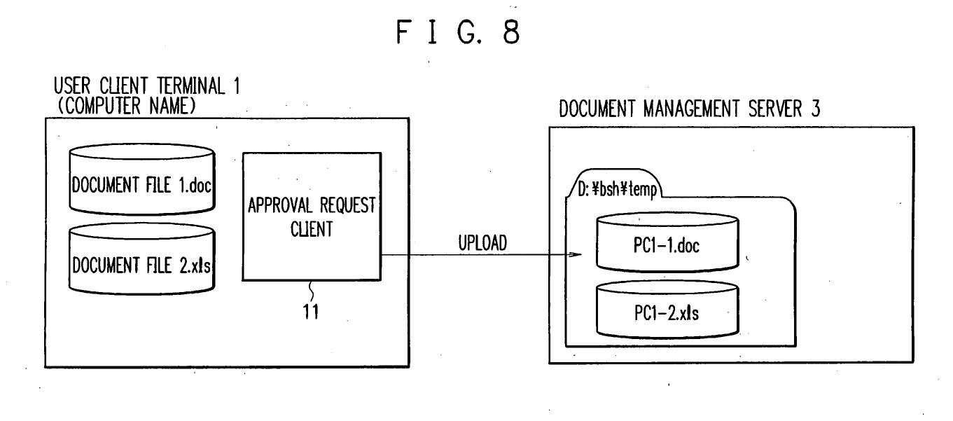

FIG. 7 shows a flow of operation in the approval request processing. When a user requesting approval of a document conducts an input operation for the document approval, the approval request client 11 uploads a document file as an object of approval to the document management server 3 (step S101). FIG. 8 shows a concrete example of operation to upload the document file from the user client terminal 1 having a terminal name of PC1 to the server 3. It is assumed in the uploading example that the document includes two files, i.e., document file 1.doc and document file 2.x1s.

In response to the request from the client 11, the approval request server program reads the document files including document file 1.doc and document file 2.x1s of the terminal 1 in a predetermined folder. In the operation, each file name is converted into a combination of a user client terminal name and a serial number with the extension code kept unchanged. In the example, the document file names are changed into PC1-1.doc and PC-2.x1s, respectively.

Next, from the terminal 1, the server program acquires information regarding a document for which the user has conducted an input operation for the client 11 and information associated with an approval flow.

By referring to a request document code contained in an incomplete approval request table, the server program attains an approval request number from a number master corresponding to the request document code (step S102). The approval request number is configured according to a numbering system of the number master. Request types available for the request document have been registered as master information (of a request type master).

If the request type indicates a request for a document issued in advance (other than a new document request), the approval request server program refers to the formal document information of documents, which have been issued, to set an on-request flag in the document table to thereby prevent any duplicate approval request for the same document.

Subsequently, the server program assigns a document number.

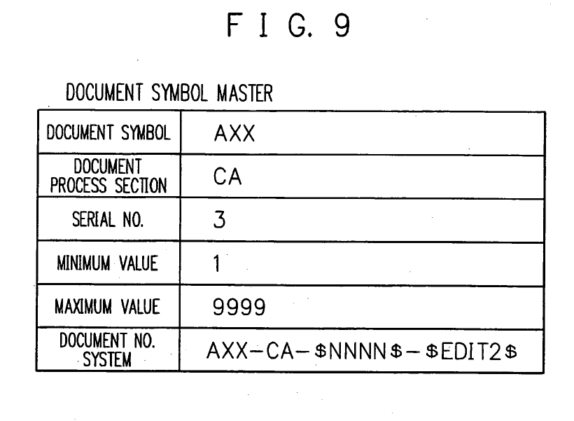

If the approval type indicates a new document issuance, the server program obtains a document serial number on the basis of the document symbol and the document process section supplied from the approval request client 11 and then assigns a document number according to the document number system. FIG. 9 shows a specific example of the document number assignment. Using the document symbol and the document process section, the server program attains a document symbol master. Thereafter, the program obtains a value of a serial number from the document symbol master and increments the value by one. The server program then replaces a part of the document number system, i.e., $NNNN$ with the incremented value. If the value of the serial number includes three digits or less, the program adds “0” thereto to produce a four-digit value. Thereafter, a part of the document number system, i.e., “$EDIT2$” is replaced by an edition number (“01” for the new document approval).

On the other hand, if the approval type is other than the new document approval, the server program refers to the formal document information of the issued documents and then increments the edition number at the end of the document number by one to thereby assign a document number.

Next, the approval request server program determines whether the information regarding the approver at each approval rank, which the client 11 attained through the input operation of the user, matches with an approval flow template. This is accomplished by comparing a post code set to the template with a post code contained in the user information supplied from the user via the approval request client 11 (step S103).

The server program also allows a plurality of approvers at any approval rank. That is, a check is made to determine whether all persons designated as approvers of a particular approval rank are at a post higher than the post indicated by the post code designated in the approval flow template.

After appropriateness of the approval flow is confirmed, the server program refers to user information according to the user identifier (ID; approval user ID) of the approver at a first approval rank to obtain information such as a mail address necessary to send an approval request notification by e-mail and then stores the information in the mail transmission data storage section 44 (step S104). The server program then sets “approval request completion flag” in the approval flow detail table of the first rank.

If the first approver is the requester of the approval request, the server program changes the item of “approver registration status” in the approval flow detail information to “completed” and then refers to the user information according to the approver user ID of the second rank. The program then attains information necessary to send an approval request notification by e-mail to store the information in the mail transmission data storage section 44. As a result, the approval registration by the requester is skipped to smoothly execute the approval processing.

For the mail or the notification messages or texts, formats are beforehand registered for respective kinds of mail. The formats include variable fields such as an approval request number and a document number. The contents of the fields are replaced by a value or a character string supplied from the approval request client 11 and/or a value obtained by the server program according to necessity. This also applies to the other clients and the other server programs.

Next, the approval request server program makes a check to confirm whether a related document has been registered for the document to be approved (presence or absence of a document request related document table). If such related document has been registered, the server program refers to the document request related document table to attain therefrom an approval request number of the related document. On the basis of the number, the server program refers to data in the formal document information storage section 42 to determine whether a document corresponding to the number has been issued (step S105).

The server program then determines whether an invalidation designation document has been registered for the document of the approval request (presence or absence of a document request invalidation document table). If such document is beforehand registered, the server program refers to the document request invalidation document table to acquire therefrom an approval request number of the invalidation designation document. Using the approval request number, the server program refers to data in the storage section 42 and determines whether a document corresponding to the number has already been issued (step S106).

After confirming presence of the related document and the invalidation designation document, the server program stores unapproved document information of the document applied for approval in the unapproved document information storage section 41 (step S107).

The server program updates the file name of the document file having uploaded from the approval request client 11 to “approval request number—serial number. extension code” and then moves the file to a predetermined folder (step S108). The program then registers the file name after conversion to the approval request document file information.

The document approval request is carried out through the operation described above.

Next, description will be given of a document conversion flow.

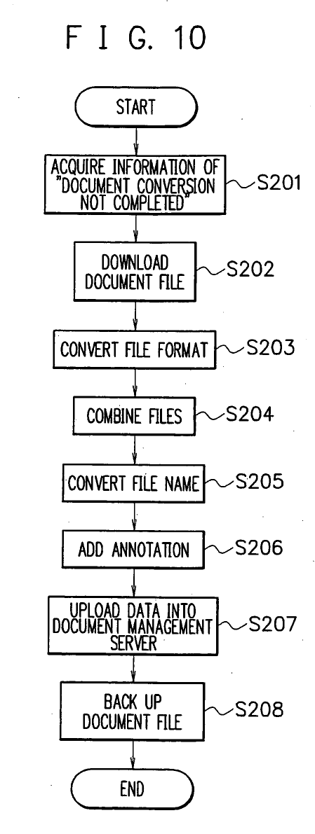

FIG. 10 shows a flow of operation of document conversion processing. Like the mail transmission client 23, the document conversion client 21 of the manager client terminal 2 similarly reads a setup file on startup. The client 21 first obtains approval request information of an electronic document of which data has been registered to the unapproved electronic document file storage section 31 and for which the document conversion has not been completed (document conversion completion flag=0; step S201). The converter client 21 requests the document conversion server program to download the document file for which the conversion has not been finished. In response thereto, the program reads a document file indicated as “document conversion not completed” from a predetermined folder and sends the file to a predetermined folder of the manager client terminal 2 (step S202). The converter client 21 converts the document file thus downloaded into a file of a particular format, e.g., a Docuworks format (step S203).

If one document includes a plurality of files, the document converting client 21 converts each file into a predetermined file format to combine converted document files with each other (step S204) and then changes the file name of the resultant document file (step S205). If the document includes only one file, the steps above are skipped in the processing.

Subsequently, the converter client 21 adds an annotation thereto at a predetermined position (step S206). The annotation is an explanatory note added to a document and is incorporated as electronic data in the document to be displayed and/or printed together with the body of the document. The annotation may include any document and any mark. For example, a character string such as a date of issuance, a mark such as a symbol of a firm, or a combination thereof may be added to each page of the document.

The annotation is employed according to necessity, that is, the addition thereof is not essential to the processing.

The document conversion client 21 then transmits the data including the annotation to the document management server 3 to upload the data in a predetermined folder therein (step S207). In response to a request from the client 21, the document conversion server program stores the data in a predetermined folder.

After the data is uploaded, the converter client 21 deletes the document file for which the conversion has been finished from the manager client terminal 2.

The client 21 also uploads the document file downloaded from the document management server 3 to a backup folder in the server 3 (step S208).

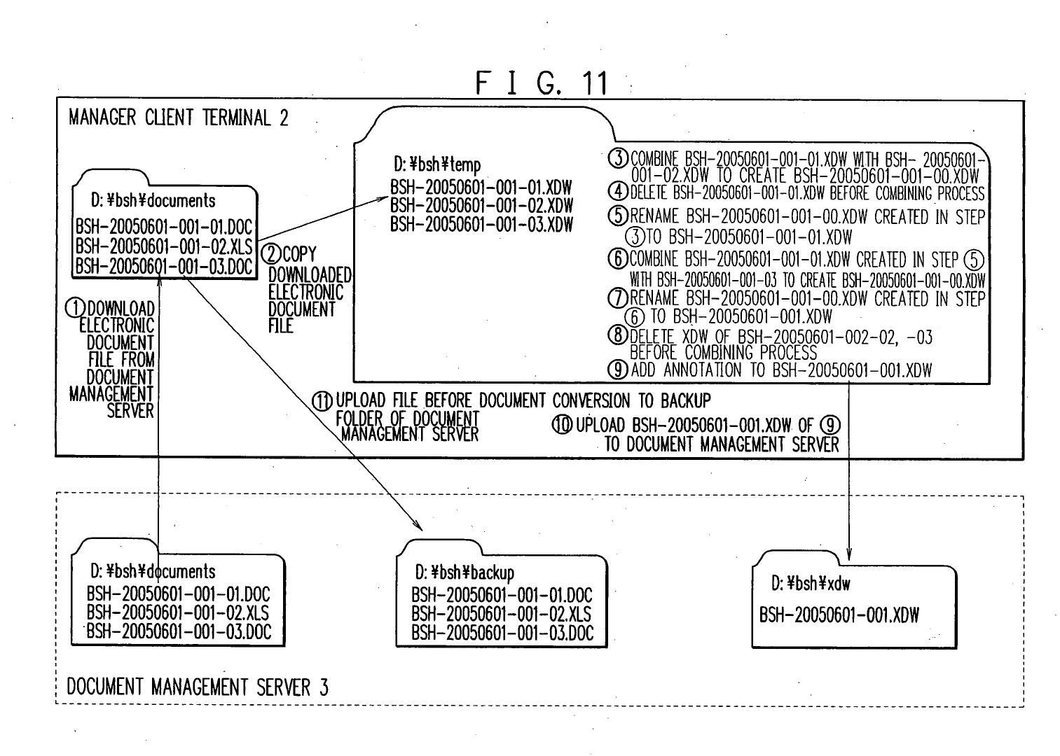

Referring now to FIG. 11, description will be given of operation at document conversion by use of a concrete example.

Assume that the document requested for approval for which the approval request server program has been processed is assigned with an approval request number of BSH-20050601-001, the request type is new issuance, and the assigned document number is AXX-CA-1234-01. Assume also that the document for the approval request includes three files, i.e., BSH-20050601-001-01.doc, BSH-20050601-001-02.xls, and BSH-20050601-001-03.doc.

The document conversion client 21 first refers to data in the unapproved document information storage section 41 of the database server 4 to obtain document file information according to the approval request number “BSH-20050601-001”. The client 21 then requests the document conversion server program to download the document file from a predetermined folder of the document management server 3 to a predetermined folder of the manager client terminal 2. During the download, the file names are kept unchanged.

Subsequently, the client 21 converts the data format of the document file into the Docuworks format in the pertinent folder. The file names are BSH-20050601-001-01.XDW, BSH-20050601-001-02.XDW, and BSH-20050601-001-03.XDW as a result. To each of the converted file, the associated before-conversion file is attached as its original. In other words, the after-conversion data includes the before-conversion data.

The document conversion client 21 then combines the after-conversion files with each other in a procedure below.

First, the client 21 arranges BSH-20050601-001-02.xdw after BSH-20050601-001-01.xdw to create a file “BSH-20050601-001-00.xdw”. Thereafter, the client 21 deletes the original BSH-20050601-001-01.xdw and then renames BSH-20050601-001-00.xdw to BSH-20050601-001-01.xdw. Finally, the client 21 arranges BSH-20050601-001-03.xdw after BSH-20050601-001-01.xdw to generate BSH-20050601-001-00.xdw.

Thereafter, the document conversion client 21 renames BSH-20050601-001-00.xdw to BSH-20050601-001.xdw and then deletes the original BSH-20050601-001-02.xdw and BSH-20050601-001-03.xdw.

The client 21 adds an annotation to the obtained document file. The client 21 requests the document conversion server program to upload BSH-20050601-001.xdw to the document management server 3 and to update the before-conversion data in a backup folder of the server 3.

As the result of the above operation, the document file format of each document file is converted, and the plural files are combined with each other into one file.

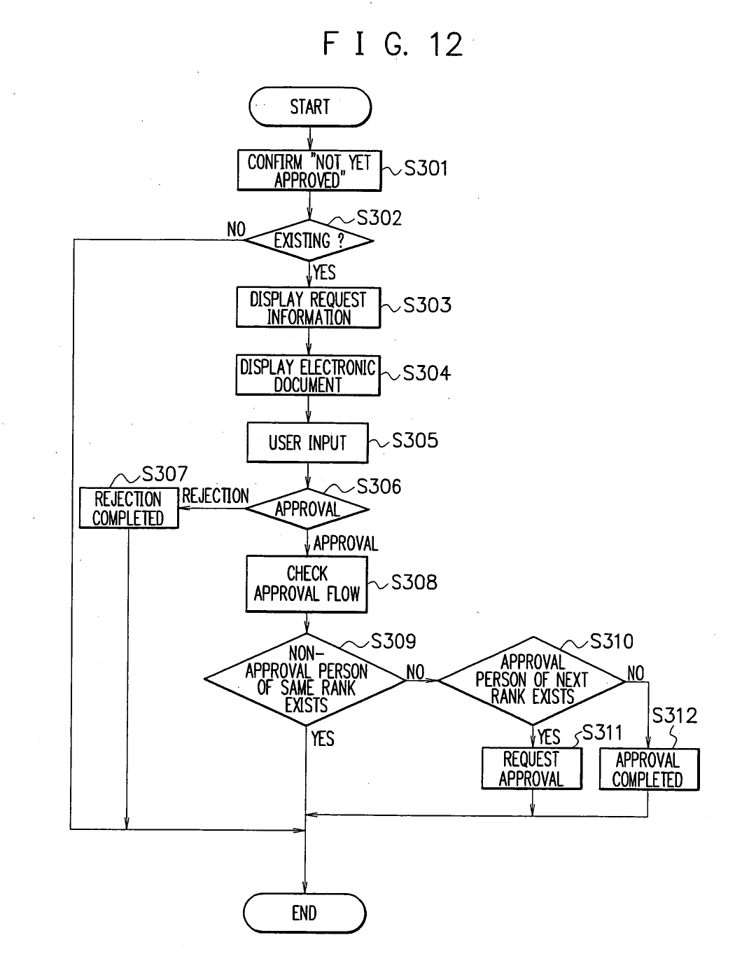

Next, description will be given of operation of the system in which a person requested for document approval gives approval of the document or rejects the approval request. FIG. 12 shows a flow of approval registration processing.

The approval registration client 12 makes a check, when the user of the user client terminal 1 conducts login to the system, to determine whether there exists a document for which the user is to conduct approval and for which the approval processing has not been executed (step S301). In the operation, the client 12 makes a check through the approval flow detail table in the unapproved information storage section 41 to determine whether there exists data for which the ID of the user has been registered as an approval user ID and of which the approval registration status is “during approval”.

If a document for which the approval processing has not been executed does not exist (no in step S302), the processing is terminated. Otherwise (yes in step S302), the client 12 reads, from the storage section 41, approval request information of the document for which the approval processing has not been executed and then presents the information to the user (step S303). When the user selects a document from the approval request information, the client 12 requests the approval registration server program to download the document. In response to the request, the program reads a document file of the document from the unapproved electronic document file storage section 31 to deliver the document file to the user client terminal 1 as the request source. After obtaining the file, the client 12 presents the document to the user (step S304).

When the user confirms the contents of the document and carries out an operation to select “approval” or “rejection”, the client 12 attains the contents of the operation (step S305). To prevent an operation in which the person only approves the document without confirming the contents thereof, it is favorable that the user can input an item for “approval” or “rejection” only after the document is displayed on the user client terminal 1.

If the user's operation indicates “rejection of the document” (rejection in step S306), the client 12 refers to the approval flow detail table to acquire the user ID of the requester and that of the approver for which the approval registration has been finished. The client 12 then refers to user information according to the user IDs to obtain mail addresses thereof, creates information to transmit thereto “rejection completion mail” indicating that the document of the approval request has been rejected, and stores the information in the mail transmission data storage section 44 (step S307). If an approver for which the approval request has been issued and for which the approval processing has not been finished is present as the result of the operation to refer to the approval flow detail table, the client 12 similarly obtains a mail address of the approver, creates information to send a message by e-mail to cancel the approval request, and then stores the information in the storage section 44.

On the other hand, if the indication from the user is “approval of the document” (approval in step S306), the client 12 refers to the detail table in the storage section 41 to confirm the approval flow (step S308).

If there exist approvers of the same rank (yes in step S309), the processing is terminated.

Otherwise (no in step S309), the client 12 determines whether there exists an approver of the next rank (step S310). If there exists such an approver (yes in step S310), the client 12 refers to the detail table to acquire the user ID of the approver of the next rank. Using the user ID, the client 12 refers to the user information to obtain a mail address of the approver, generates data to prepare mail data of the document approval request, and stores the data in the storage section 44 (step S311). If there exist a plurality of approvers of the next rank, the client 12 produces mail transmission data to send the approval request mail to all of the approvers.

If there does not exist any other approver of the same rank (no in step S310), the approver is the final approver, and hence the client 12 updates the status to “approval completion” in the approval request information. The client 12 then creates information to e-mail message notifying completion of the authentication processing to the requester and stores the information in the storage section 44 (step S312).

Thereafter, the mail transmission client 13 sends the transmission data stored in the storage section by the client 12 to the mail server 5. The server 5 delivers the data to the respective destinations.

Through the operation, the document requested for approval is approved or rejected.

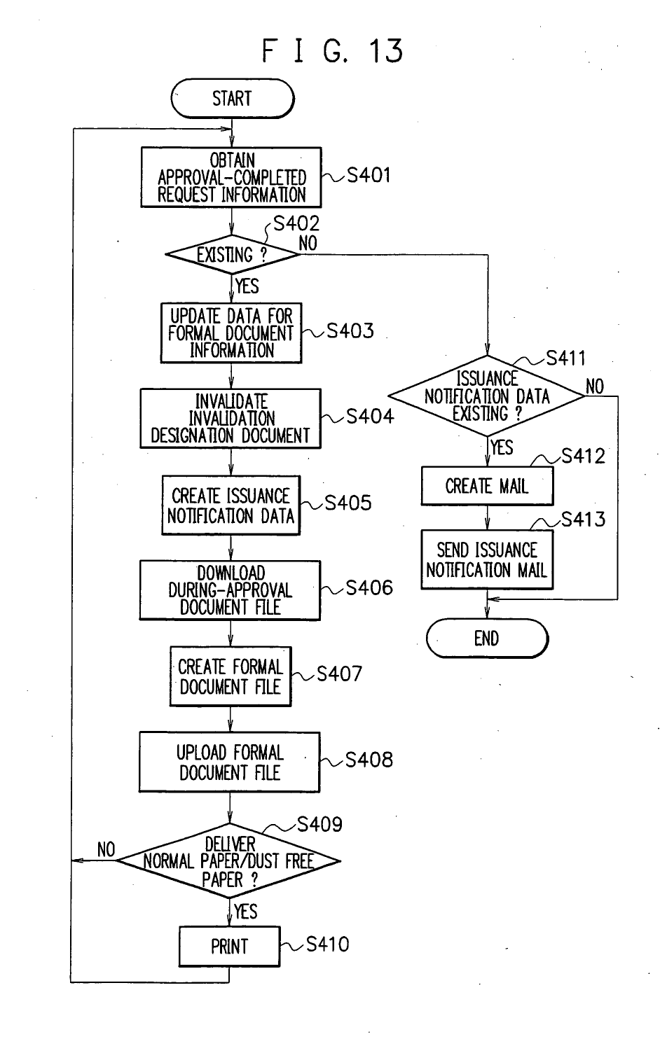

Description will now be given of a flow of operation in the processing to issue a document. FIG. 13 shows an operation flow of the document issuance. The operation is initiated when the document issuance client 22 sends a trigger to the document issuance server program at predetermined timing.

The server program refers to the approval request table of the unapproved document information to determine whether there exists a document of which the status is “approval completion” (step S401). If such a document exists (yes in step S402), the server program produces formal document information by using the unapproved document information in the storage section 41 and stores the information in the formal document information storage section 42 (step S403). In the operation, the server program generates document issuance history information as data associated with the document information regardless of the request type. The approval flow detail information is created as data attached to the document issuance history information. The delivery destination information, the invalidation document information, and the related document information are produced as data items accompanying the document information.

Additionally, the document issuance program obtains, if an invalidation designation document exists for the pertinent document, document information of the document as an object of invalidation on the basis of the designated items such as the document symbol, the document section, and the serial number, and then executes processing to invalidate the document (step S404). Specifically, the item of “document status” is updated to “invalid” in the document information of the document.

The document issuance server program then produces data items such as a document number and a destination mail address which are required to send “issuance notification mail” indicating a document issued as a formal document and “invalidation notification mail” designating a document thus invalidated (step S405). For this purpose, the server program refers to the delivery destination information of the document to be issued.

The server program then accesses the file storage section 31 to read therefrom the file of the document to be issued as a formal document and then downloads the file to a predetermined folder of the manager client 2 (step S406).

Using the approval flow detail information of the document downloaded as above, the document issuance client 22 generates approval history information. The client 22 produces, as the information, text data having a file name of, for example, “approval-request-no-rireki.txt”.

The client 22 converts the text data into the Docuworks format, adds an annotation to the data if necessary, and then places the data in the last part of the downloaded document file to resultantly creates a formal electronic document file (step S407).

The document issuance client 22 uploads the document file to the storage section 32 (step S408). The uploaded file is data as the original of the formal document. After the document file is completely uploaded, the server program updates the document status to “issuance completion” in the document information thereof.

Next, the server program refers to the delivery destination information to determine whether delivery with ordinary paper or dust free paper is needed (S409). If such demand exists (yes in step S409), the server program refers to the division information to acquire information (designating a delivery destination printer) indicating a printer of the delivery destination. The server program requests the printer to print the number of documents determined by the delivery destination information (step S410). The server program then returns to step S401 to confirm whether there exists a document of which the status is “approval completion”. If such a document exists, the program again conducts operation similar to that described above.

If there does not exist designation for delivery of ordinary paper or dust free paper (no in step S409), the server program similarly returns to step S401 and determines whether there exists a document of which the status is “approval completion”. If this is the case, the program executes processing similar to that described above.

If there does not exist a document of which the status is “approval completion” (no in step S402), the document issuance server program determines whether there exists issuance notification data (step S411). If the data is present (yes in step S411), the program produces issuance notification mail and invalidation notification mail according to a predetermined format (step S412). If it is desired to send a plurality of issuance notification mail pieces and a plurality of invalidation notification mail pieces to one destination, it is also possible to collect the mail pieces into one issuance notification mail piece and one invalidation notification mail piece. For example, to notify issuance of documents A and B to division A, it is possible to create one mail piece including the issuance of documents A and B to division A. If it is desired to send issuance notification mail pieces and invalidation notification mail pieces to one division, the two types of mail pieces may be separately prepared. For example, to notify issuance of documents A and B and invalidation of documents C and D to division A, a mail piece (for issuance notification) to notify issuance of documents A and B and a mail piece (for invalidation notification) to notify invalidation of documents C and D may be separately produced.

After the issuance notification mail pieces and the invalidation notification mail pieces are generated, the server program sends the mail pieces to the mail server 5 to request transmission thereof (step S413).

As the result of the operation, the document thus approved is issued.

If the validation expiration time has been set to the document, the system executes processing to invalidate the document at a predetermined point of time. The operation will be described.

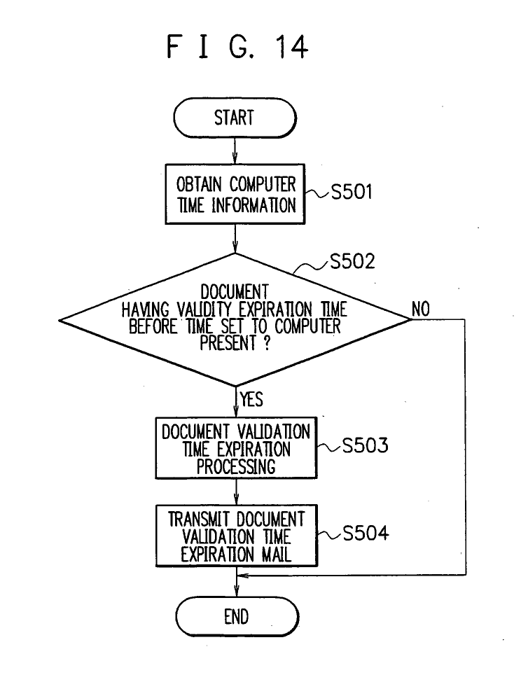

FIG. 14 shows a flow of the operation in the document validation time expiration processing.

A document validation time expiration processing program included in the server program 33 is booted at a predetermined time, e.g., at 12 o'clock midnight everyday, to acquire time information registered to the document management server 3 (step S501). The document issuance server program refers to the formal document information stored in the formal document information storage section 42 of the database server 4 to determine presence or absence of a document having a document validation expiration time before the current point of time (step S502). If there exists a document of which the validation expiration time has passed (yes in step S502), the program updates the document status to “invalid” in the document table of the normal document information (step S503). Thereafter, the document validation time expiration program refers to the delivery destination table and creates “expiration mail” with a destination set as the delivery destination of the document thus invalidated, the expiration mail notifying that the document has been invalidated because of the expiration of the document validity time (step S504). The mail data is then stored in the mail transmission data storage section 44 to be later delivered therefrom by the mail transmission client 23.

With this operation, the document of which the validity time has expired is invalidated.

As above, the approval request and the approval registration are carried out for the document, and then the document thus approved is issued. However, there also exists a situation in which the approval flow needs to be altered for some reason. Description will now be given of operation to alter the approval flow.

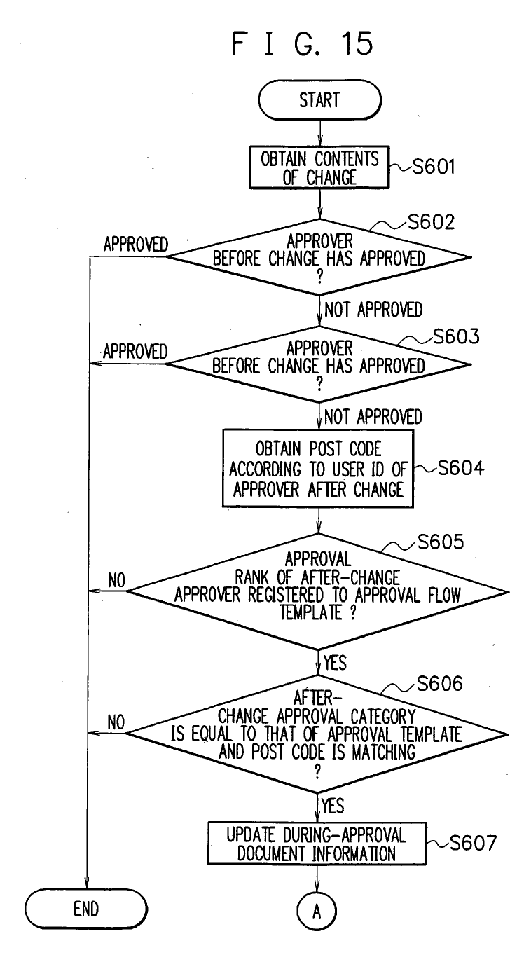

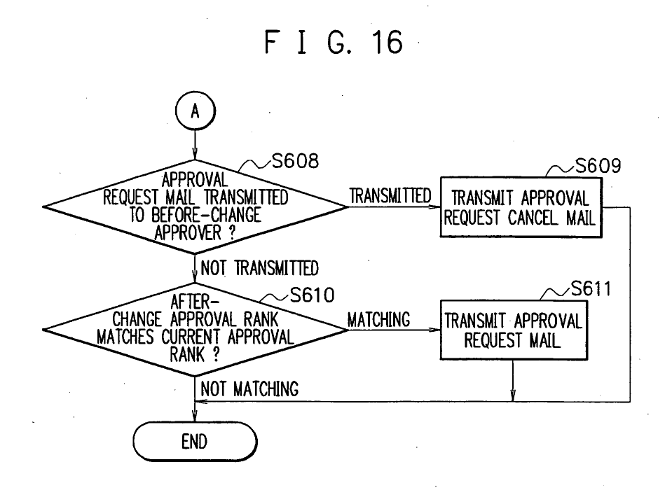

FIGS. 15 and 16 show a flow of operation in the approval flow change processing.

The approval change client 13 is first activated and then attains a user ID of the user of the user client terminal 1. Based on the user ID, the client 13 refers to the approval request information in the unapproved document information storage section 41 to obtain an approval request number of an unapproved document for which the item of the requester user ID matches the user ID of the own terminal. The client 13 presents the approver request number to the user for selection. According to the approval request number selected as the result of an input operation by the user, the client 13 executes the approval flow change processing. That is, for the document for which the approval request has been once issued, only the requester is capable of changing the approval flow of the document.

The client 13 presents the current approval flow to the user, requesting that the user specify places to be changed and inputs the details of the change (step S601). When the user inputs data to a particular position of the approval flow, the client 13 refers, according to the position, to the item of the approval registration status in the approval flow detail table to determine whether the approver before the change has already conducted the approval operation (step S602).

If the approver has already approved (approved in step S602), the client 13 does not approve the change of the approval flow for the position to thereby terminate the processing. Otherwise (not approved in step S602), the client 13 notifies the contents of the change to an approval change server program. After having received the notification, the program refers to the item of the approval registration status in the approval flow detail table to determined whether the approver before the change has already approved (step S603).

If the approver has already approved (approved in step S603), the client 13 terminates the processing without allowing the change in the approval flow for the position. Otherwise (not approved in step S603), the approval change server program obtains a post code of the approver according to the user ID of the after-change approver (step S604).

For the position of which the approval rank has been altered, a check is made to determine whether the approval rank of the after-change approver has been registered to the approval template. For example, if “limit sample—revision” has been selected as a template in the approval template shown in FIG. 5, the approval rank takes a value ranging from one to three. Therefore, the check is made to determine whether the after-change approval rank is within the range (step S605).

If the approval rank is beyond the registered range (no in step S605), the approval flow change is not allowed and the processing is terminated. If the rank is within the range registered to the approval flow template (yes in step S605), a check is made to determine whether the after-change approval category is equal to that registered to the template and whether the post of the after-change approver is higher than the lowest position registered to the template (step S606). For example, if the approval flow template is “limit sample—revision”, it is required that approval rank 1 is “inspection”, approval rank 2 is “approval”, and approval rank 3 is “consultation”. That is, for the contents of a change to set “approval” to approval rank 1, it is determined that the contents do not match the contents of the template. The lowest post having the right of approval is “group leader” for approval rank 1, “section manager” for approval rank 2, and “group leader” for approval rank 3. Therefore, for the contents of a change to designate, as the approver at approval rank 2, a person at a post of a group leader, it is determined that the approver after the change does not has the right of approval. If the after-change approval category does not match the contents of the template or the after-change approver does not have the right of approval (no in step S606), the approval change server program terminates the processing without allowing the approval flow alteration. On the other hand, if the after-change approval category matches the contents registered to the template or the after-change approver possesses the right of approval (yes in step S606), the program updates the unapproved document information (the approval flow detail table; step S607).

If the approver has been changed, the approval change server program refers to the approval flow detail table to determine whether an approval request has been transmitted to the before-change approver (step S608). If the request has already been issued (transmitted in step S608), the program refers to the user information on the basis of the user ID of the approver to produce mail data notifying cancellation of the approval request and then stores the data in the mail transmission data storage section 44 (step S609).

If the approval request has not been issued (not transmitted in step S608), the program determines whether the approval rank of the changed position matches the current rank (step S610). If the ranks do not match each other (not matching), the program creates approval request mail data for the after-change approver to store the data in the storage section 44 (step S611).

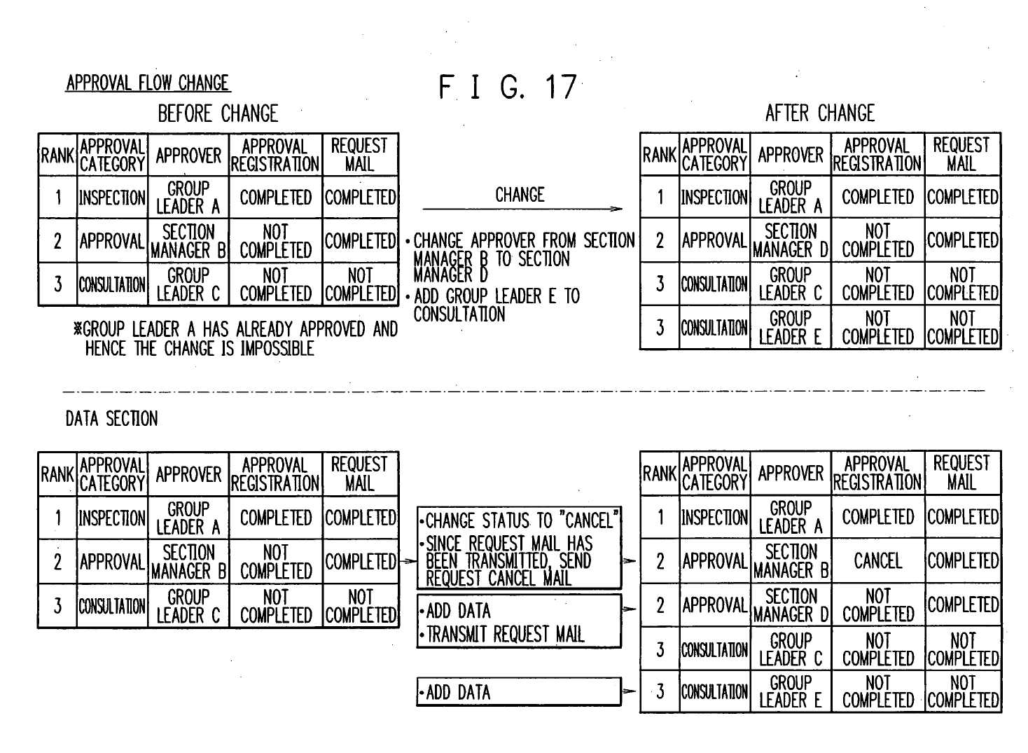

FIG. 17 shows a specific example of the approval flow change. Assume that section manager B of rank 2 is replaced by section manager D and group leader E is added as person of rank 3.

First, since the approval registration has been completed for group leader A of rank 1, if the user issues a request to change the item, the approval change client 13 rejects the request. However, since the change request is associated with section manager B for which the approval registration has not been completed, the client 13 makes a check to determine whether the other requirements are met. The request is not a request to change the approval category. In the change to set section manager D as the approver of rank 2 and the change to add group leader E as an approver, the before-change approver and the person to be set as an after-change approver have the same rank. Therefore, the client receives the approval flow change request as a valid request and notifies the contents of the change to the approval change server program.

The program having received the notification confirms whether the after-change approval flow conforms to the approval flow template, in almost the same way as described above. In this situation, the flow conforms to the template, and hence the program updates the unapproved document information.

Since the approval request mail has already been sent to the before-change approver, i.e., section manager B, the program generates approval request cancel mail data. Since the section manager D as the after-change approver is an approver of the current approval rank, the program produces approval request mail for section manager D. Group leader E additionally designated as an approver of rank 3 is other than the approver of the current rank, and hence the program does not create approval request mail for group leader E.

In the approval request cancellation, the program does not delete the associated item of the approval flow detail information (or does not write the item over the existing data item), but updates the approval registration status to “cancel”. The event that the approval request has been cancelled resultantly remains in the history.

As above, the approval change client 13 and the approval change server program allow the approval flow change only within the range in which the change conforms to the approval flow template specified in advance. Therefore, even if the requester changes the approval flow, the job can be continuously carried out without any trouble.

Additionally, it is inhibited to change the approver for whom the approval processing has already been finished. Therefore, the approval processing completed before is kept effective in the system.

In a case where the approval change client 13 and the approval change server program conduct the same check in a duplicate way, even if an approver who has not completed the approval in the check by the client 13 has finished the approval later, it is possible for the program to reject the approval change request.

### Second Embodiment

Description will now be given of a second embodiment in accordance with the present invention. The embodiment is configured in almost the same way as the first embodiment.

In the second embodiment, for convenience of users, documents to be approved in future are presented to the users waiting for approval operation. This helps the users prepare for the approval and carry out approval smoothly. Assume that a user awaiting his or her turn to accomplish the approval operation browses documents associated with the approval before her or his turn for approval and registers results of approval of the documents thus browsed. When the approval request is received, the user sets the approval results as formal approval results to thereby carry out the approval flow quite smoothly.

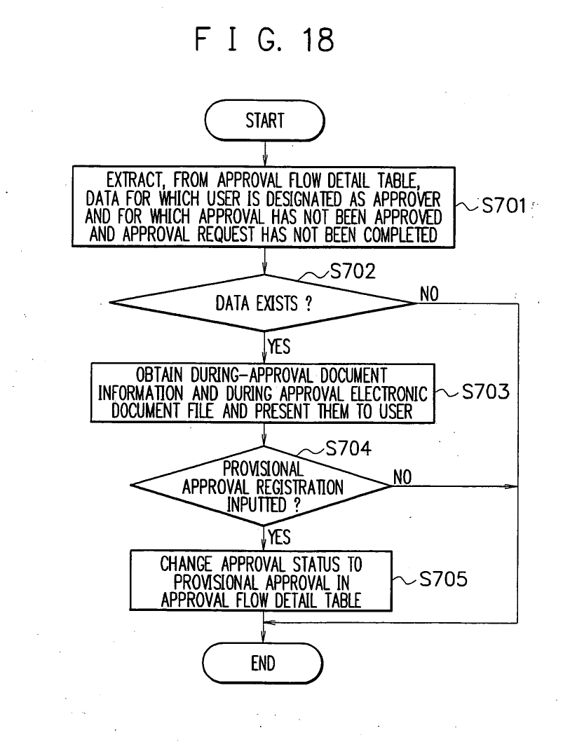

FIG. 18 shows a flow of operation of the approval reservation processing in an electronic document browsing system according to the second embodiment.

The approval registration client 12 refers to the approval flow detail table to determine whether there exists a document file for which the user of the user client terminal 1 has been registered as an approver and the approval request completion flag is “not completed” (step S701). If such data exists (yes in step S702), the client 12 requests the approval registration server program to download the document file to resultantly attain the document file. The client 12 accesses the storage section 41 to obtain therefrom unapproved document information of the document file. The client 12 presents the information to the user for confirmation (step S703). When the user conducts operation for provisional approval registration (yes in step S704), the client 12 changes the item of the approval registration status to “provisional approval” in the approval flow detail table for which the user of the user client terminal 1 is specified as an approver (step S705).

If there does not exists a document file for which the user of the terminal 1 is registered as an approver and the approval request completion flag is “not completed” (no in step S702) or if the user does not conduct an input operation for the provisional approval registration (no in step S704), the processing is terminated.

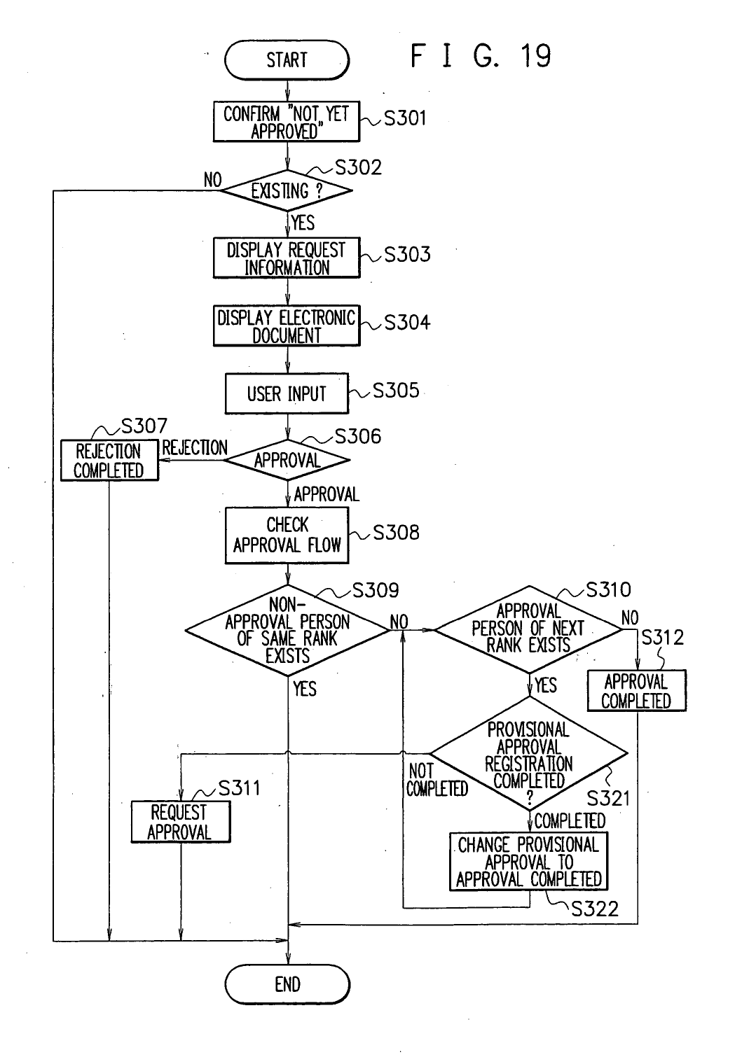

FIG. 19 shows an operation flow of ordinary approval registration in the system of the second embodiment. Although the operation is similar to that of the first embodiment, the second embodiment additionally includes steps S321 and S322.

If the user approves a document, the document registration client 12 determines whether an approver of the next rank exists. If such approver exists (yes in step S310), a check is made to determine whether the approver has already conducted a provisional approval (step S321).

If the approver has not conducted the provisional approval (not completed in step S321), the approval request mail is delivered to the approver as in the first embodiment (step S311). Otherwise (completed in step S321), the client 12 changes the approval registration status from “provisional approval” to “approval completed” in the approval flow detail information of the pertinent approver (step S322). Thereafter, the client 12 determines whether an approver of the further next rank exists (step S310).

In a case where the user rejects the approval of the document, the document registration client 12 produces data to indicate the rejection to an approver (waiting for approval) of a higher rank and then stores the data in the storage section 44. As a result, the approver awaiting approval can recognize that the document to be approved has been rejected and it is not required to confirm the contents of the document.

If an approver of a higher rank rejects the document in the approval processing, the document is rejected regardless of the results of approval by any approver of a lower rank. Therefore, it is also possible to interrupt the approval flow when the rejection is reserved by an approver waiting for approval.

Since the approval flow may be changed also in the second embodiment, it is similarly possible to stop the flow after the reserved result is designated as a formal result. Naturally, when approval or rejection is reserved by an approver waiting for approval, the approval flow change regarding the approver may be inhibited.

### Third Embodiment

Description will now be given of a third embodiment in accordance with the present invention. The embodiment is almost equal in system structure to the first embodiment.

In the third embodiment, if an approver has not conducted the approval operation within a predetermined period of approval time, the electronic document browsing system replaces the approver by a predetermined approver.

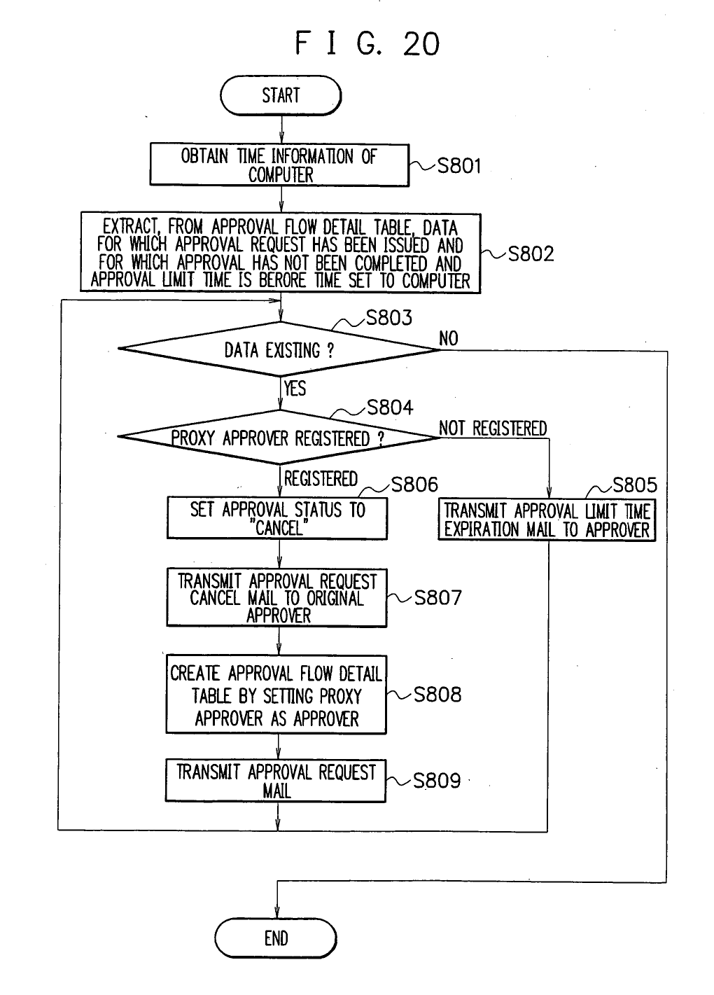

FIG. 20 shows a flow of operation in the approver change processing.

The approver change client 13 attains time information set to the user client terminal 1 (step S801). The client 13 refers to the approval flow detail table to determine whether there exists an unapproved document file for which the approval request has been issued and for which the approval has not been completed and the approval time limit is before the time set to the client terminal 1 (step S802).

If there exists such document file (yes in step S803), the client 13 determines whether a proxy approver has been set to the approval flow detail table of the approval request (step S804).

Otherwise (no in step S804), the client 13 produces mail data to notify expiration of the approval limit time to the approver and stores the data of the mail data in the storage section 44 (step S805).

If a proxy approver has been registered (“registered” in step S804), the client 13 changes the item of the approval registration status to “cancel” in the approval flow detail table of the approval request (step S806).

The client 13 produces mail data to notify cancellation of the approval request to the approver cancelled as above and stores the data in the storage section 44 (step S807).

The client 13 then generates an approval flow detail table by designating the proxy approver as the approver (step S808).

According to the table thus created, the client 13 creates mail data, the data requesting the approver (original approver) to approve the document. The client 13 then stores the data in the storage section 44 (step S809).

The approval change client 13 repeatedly carries out the operation for all data items (i.e., until the branch of “no” is effective in step S803).

In the third embodiment, when the proxy approver has been registered in each stage of the authentication flow, if the approval period of time has passed, the document approval request can be automatically issued to the proxy approver. As a result, the authentication flow hardly becomes stagnant in any situation.

Incidentally, the first to third embodiments are only examples of embodiments in accordance with the present invention. That is, the present invention is not restricted by the embodiments.

For example, the file format of the document requested for approval is converted into a particular format in the examples of the respective embodiments. However, it is not necessarily required to accomplish the file format conversion.

Although the document management server 3 is separated from the database server 4 in the configurations of the embodiments, the servers 3 and 4 may be constructed in one unit.

One of the user clients 1 can include the function of the manager client terminal 2.

In the first embodiment, the requester is able to freely change the approval flow. However, for the approval flow change, there may also be disposed a restriction other than that of the approval flow template. For example, the range of approval flow change may be determined by an approver of the rank higher than that of the requester, the approver being, for example, an approver of the rank equal to or higher than a section manager in one and the same division.

According to the example of the third embodiment, the document approval request is issued to the proxy approver when the approval limit time is expired. However, the request for the document approval may be sent to the proxy approver before the lapse of the approval limit time. For example, the system may also be configured such that an event in which the user cannot approve a document, for example, due to a long absence of a business trip, can be automatically registered. For the user for whom the event is beforehand registered, when it is his or her turn for the document approval, the approval of the requested document may be issued to the proxy approver.

As above, various changes and modifications of the embodiments are possible in accordance with the present invention.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

1. A document management system comprising at least one user client terminal and a server connected via a network thereto for circulating document data as an object of circulation through a plurality of users of the client terminal, wherein
the user client terminal comprises:
means for obtaining circulation route information representing a circulation order of circulation objective document data that is an object of circulation, by circulation target persons and circulation ranks;
means for transmitting the circulation objective document data and the circulation route information to the server;
means for transmitting a transmission request of the circulation objective document data to the server;
means for receiving the circulation objective document data from the server;
means for outputting therefrom the circulation objective document data received from the server;
means for obtaining an approval result for the circulation objective document data outputted from the output means; and
means for transmitting the approval result to the server; and
the server comprises:
circulation rule information storage means having stored therein at least one circulation rule information item indicating a rule to circulate document data;
means for determining whether the circulation order represented by the circulation route information obtained from the user client terminal conforms with the rule indicated by the circulation rule information stored in the circulation rule information storage means; and
means for transmitting, in response to a request from the user client terminal, the circulation objective document data of which the circulation order is determined to conform with the circulation rule information,
wherein a plurality of circulation target persons are specifiable for one and the same circulation rank in the circulation route information.

2. A document management system in accordance with claim 1, wherein
the user client terminal comprises:
means for obtaining a change position of the circulation order of the circulation objective document data; and
means for notifying the change position of the circulation order to the server; and
the server comprises:
means for obtaining a circulation status of the circulation objective document data for which the change position of the circulation order is notified from the user client terminal;
means for determining whether the change position of the circulation order notified from the user client terminal changes a circulation target person for whom the circulation objective document data has not been circulated;
means for determining whether a circulation order after a change of the change position of the circulation order conforms to the rule indicated by the circulation rule information; and
means for allowing the change of the circulation order if the change position of the circulation order changes a circulation target person for whom the circulation objective document data has not been circulated and the change of the change position conforms to the rule indicated by the circulation rule information.

3. A document management system comprising at least one user client terminal and a server connected via a network thereto for circulating document data as an object of circulation through a plurality of users of the client terminal, wherein
the user client terminal comprises:
means for obtaining circulation route information representing a circulation order of circulation objective document data as an object of circulation, by circulation target persons and circulation ranks;
means for transmitting the circulation objective document data and the circulation route information to the server;
means for transmitting a transmission request of the circulation objective document data to the server;
means for receiving the circulation objective document data from the server;
means for outputting therefrom the circulation objective document data received from the server;
means for obtaining an approval result for the circulation objective document data outputted from the output means;
means for transmitting the approval result to the server;
means for obtaining, through an operation by the user, a change position of the circulation order of circulation objective document data for which the user of the own terminal is a requester; and
means for notifying the change position of the circulation order to the server; and
the server comprises:
circulation rule information storage means having stored therein at least one circulation rule information item indicating a rule to circulate document data;
means for determining whether the circulation order represented by the circulation route information obtained from the user client terminal conforms to the rule indicated by the circulation rule information stored in the circulation rule information storage means;
means for transmitting, in response to a request from the user client terminal, the circulation objective document data of which the circulation order is determined to conform with the circulation rule information;
means for obtaining a circulation status of the circulation objective document data of which the change position of the circulation order is notified from the user client terminal;
means for determining whether the change position of the circulation order changes a circulation target person for whom the circulation objective document data has not been circulated;
means for determining whether a circulation order after a change of the change position of the circulation order conforms with the rule indicated by the circulation rule information; and
means for allowing the change of the circulation order if the change position of the circulations order changes a circulation target person for whom the circulation objective document data has not been circulated and the change of the change position conforms with the rule indicated by the circulation rule information.

4. A document management system in accordance with claim 3, wherein a plurality of circulation target persons are specifiable for one and the same circulation rank in the circulation route information.

5. A document management system in accordance with claim 1, wherein the server comprises means for conducting notification after the circulation of the circulation objective document data is completely conducted by a circulation target person of a particular circulation rank, if the circulation has not been completely conducted for a circulation target person of a subsequent circulation rank during a predetermined period of time,
the notification notifying a lapse of the predetermined period of time to a circulation target person for whom the circulation objective document data has not been circulated.

6. A document management system in accordance with claim 1 wherein after the circulation of the circulation objective document data is completely conducted by a circulation target person of a particular circulation rank, if the circulation has not been completely conducted for a circulation target person of a subsequent circulation rank during a predetermined period of time and if a proxy circulation target person is beforehand registered to the circulation objective document data, the server changes the circulation order by setting the proxy circulation target person as a formal circulation target person.

7. A document management system in accordance with claim 1 the user client terminal comprises:
means for obtaining as circulation scheduled document data from the server, circulation objective document data for which the user of the own terminal is designated as a circulation target person and the person waiting for her or his turn for circulation of the document data; and
means for outputting therefrom the circulation scheduled document data.

8. A document management system in accordance with claim 7, wherein:
the user client terminal comprises:
means for obtaining an approval result for the circulation scheduled document data; and
means for transmitting the approval result to the server; and
the server confirms, at completion of the circulation by the circulation target person of a particular circulation rank, whether an approval result for the circulation scheduled document data by a circulation target person of a subsequent circulation rank has been registered, and assumes the approval result as an approval result of the circulation objective document data if the approval result has been registered.

9. A document management system in accordance with further comprising means for converting, when the circulation objective document data includes data groups of mutually different two or more file formats, the file formats into one particular file format and combining the data groups with each other into one data group.

10. A document management system in accordance with claim further comprising means for notifying, at completion of the circulation of the circulation objective document data by a circulation target person of a lowest circulation rank, completion of the circulation objective document data to a predetermined user.

11. A document management system in accordance with claim 1, further comprising means for notifying, if the authentication result of the circulation objective document data of a particular circulation rank is rejection, the rejection of the circulation objective document data to the circulation requester of the circulation objective document data and circulation target persons of a circulation rank higher than the circulation rank associated with the rejection.

12. A document management system comprising at least one user client terminal, a manager client terminal, a server, and a database connected via a network to each other for circulating document data as an object of circulation through a plurality of users of the client terminal, wherein
the user client terminal comprises:
means for obtaining circulation route information representing a circulation order of circulation objective document data as an object of circulation, by circulation target persons and circulation ranks;
means for transmitting the circulation objective document data and the circulation route information to the server;
means for transmitting a transmission request of the circulation objective document data to the server;
means for receiving the circulation objective document data from the server;
means for outputting therefrom the circulation objective document data received from the server;
means for obtaining an approval result for the circulation objective document data outputted from the output means; and
means for transmitting the approval result to the server;
the database comprises:
circulation rule information storage means having stored therein at least one circulation rule information item indicating a rule to circulate document data;
unapproved document information storage means for storing therein unapproved document information indicating a status of a document file in circulation; and
formal document information storage means for storing therein formal document information indicating a status of a document file for which the circulation has been completed;
the server comprises:
means for obtaining, from the database, the circulation rule information according to the circulation route information obtained from the user client terminal;
means for determining whether the circulation order represented by the circulation route information obtained from the user client terminal conforms with the rule indicated by the circulation rule information obtained from the database; and
means for transmitting, in response to a request from the user client terminal, the circulation objective document data of which the circulation order is determined to conform with the circulation rule information,
a plurality of circulation target persons being specifiable for one and the same circulation rank.

13. A client terminal, comprising:
means for communicating information via a network with a server;
means for obtaining circulation route information representing a circulation order of circulation objective document data as an object of circulation, by circulation target persons and circulation ranks;
means for transmitting the circulation objective document data and the circulation route information to the server;
means for transmitting a transmission request of the circulation objective document data to the server;
means for receiving the circulation objective document data from the server;
means for outputting therefrom the circulation objective document data received from the server;
means for obtaining an approval result for the circulation objective document data outputted from the output means; and
means for transmitting the approval result to the server,
wherein a plurality of circulation target persons are specifiable for one and the same circulation rank in the circulation route information.

14. A client terminal in accordance with claim 13, further comprising:
means for obtaining a change position of the circulation order of the circulation objective document data; and
means for notifying the change position of the circulation order to the server.

15. A client terminal, comprising:
means for communicating information via a network with a server;
means for obtaining circulation route information representing a circulation order of circulation objective document data as an object of circulation, by circulation target persons and circulation ranks;
means for transmitting the circulation objective document data and the circulation route information to the server;
means for transmitting a transmission request of the circulation objective document data to the server;
means for receiving the circulation objective document data from the server;
means for outputting therefrom the circulation objective document data received from the server;
means for obtaining an approval result for the circulation objective document data outputted from the output means;
means for transmitting the approval result to the server;
means for obtaining a change position of the circulation order of the circulation objective document data; and
means for notifying the change position of the circulation order to the server.

16. A client terminal in accordance with claim 13, wherein a plurality of circulation target persons are specifiable for one and the same circulation rank in the circulation route information.

17. A client terminal in accordance with claim 13, comprising:
means for obtaining as circulation scheduled document data from the server, circulation objective document data for which the user of the own terminal is designated as a circulation target person and the person waiting for her or his turn for circulation of the document data; and
means for outputting therefrom the circulation scheduled document data.

18. A client terminal in accordance with claim 17, comprising:
means for obtaining an approval result for the circulation scheduled document data; and
means for transmitting the approval result to the server.

19. A server connected via a network to at least one user client terminal, comprising:
circulation rule information storage means having stored therein at least one circulation rule information item indicating a rule to circulate document data;
means for obtaining, from the user client terminal, circulation route information representing a circulation order of circulation objective document data as an object of circulation, by circulation target persons and circulation ranks;
means for determining whether the circulation order represented by the circulation route information obtained from the user client terminal conforms with the rule indicated by the circulation rule information stored in the circulation rule information storage means; and
means for transmitting, in response to a request from the user client terminal, the circulation objective document data of which the circulation order is determined to conform with the circulation rule information,
wherein a plurality of circulation target persons are specifiable for one and the same circulation rank in the circulation route information.

20. A server in accordance with claim 19, comprising:
means for obtaining a change position of the circulation order of the circulation objective document data from each of the user client terminals;
means for obtaining a circulation status of the circulation objective document data for which the change position of the circulation order is obtained from the user client terminal;
means for determining whether the change position of the circulation order obtained from the user client terminal changes a circulation target person for whom the circulation objective document data has not been circulated;
means for determining whether a circulation order after a change of the change position of the circulation order conforms with the rule indicated by the circulation rule information; and
means for allowing the change of the circulation order if the change position of the circulation order changes a circulation target person for whom the circulation objective document data has not been circulated and the change of the change position conforms with the rule indicated by the circulation rule information.

21. A server connected via a network to at least one user client terminal, comprising:
circulation rule information storage means having stored therein at least one circulation rule information item indicating a rule to circulate document data;
means for obtaining, from the user client terminal, circulation route information representing a circulation order of circulation objective document data as an object of circulation, by circulation target persons and circulation ranks;
means for determining whether the circulation order represented by the circulation route information obtained from the user client terminal conforms with the rule indicated by the circulation rule information stored in the circulation rule information storage means;
means for transmitting, in response to a request from the user client terminal, the circulation objective document data of which the circulation order is determined to conform with the circulation rule information;
means for obtaining a circulation status of the circulation objective document data for which the change position of the circulation order is notified from the user client terminal;
means for determining whether the change position of the circulation order notified from the user client terminal changes a circulation target person for whom the circulation objective document data has not been circulated;
means for determining whether a circulation order after a change of the change position of the circulation order conforms with the rule indicated by the circulation rule information; and
means for allowing the change of the circulation order if the change position of the circulation order changes a circulation target person for whom the circulation objective document data has not been circulated and the change of the change position conforms with the rule indicated by the circulation rule information.

22. A server in accordance with claim 21, wherein a plurality of circulation target persons are specifiable for one and the same circulation rank in the circulation route information.

23. A server in accordance with claim 19, comprising means for conducting notification after the circulation of the circulation objective document data is completely conducted by a circulation target person of a particular circulation rank, if the circulation has not been completely conducted for a circulation target person of a subsequent circulation rank during a predetermined period of time,
the notification notifying a lapse of the predetermined period of time to a circulation target person for whom the circulation objective document data has not been circulated.

24. A server in accordance with claim 19, wherein after the circulation of the circulation objective document data is completely conducted by a circulation target person of a particular circulation rank, if the circulation has not been completely conducted for a circulation target person of a subsequent circulation rank during a predetermined period of time and if a proxy circulation target person is beforehand registered to the circulation objective document data, the server changes the circulation order by setting the proxy circulation target person as a formal circulation target person.

25. A server in accordance claim 24, comprising:
means for transmitting as circulation scheduled document data, in response to a request from the user client terminal, circulation objective document data for which the user of the, user client terminal as a request source is designated as a circulation target person and the person waiting for her or his turn for circulation of the document data, to the user client terminal as a request source;
means for obtaining an approval result for the circulation scheduled document data from the user client terminal; and
means for confirming, at completion of the circulation by the circulation target person of a particular circulation rank, whether an approval result for the circulation scheduled document data by a circulation target person of a subsequent circulation rank has been registered, and assuming the approval result as an approval result of the circulation objective document data if the approval result has been registered.

26. A client program for making a computer controlling a client terminal having a function to communicate information with a server connected via a network thereto function as:
means for obtaining circulation route information representing a circulation order of circulation objective document data as an object of circulation, by circulation target persons and circulation ranks;
means for transmitting the circulation objective document data and the circulation route information to the server;
means for transmitting a transmission request of the circulation objective document data to the server;
means for receiving the circulation objective document data from the server;
means for outputting therefrom the circulation objective document data received from the server;
means for obtaining an approval result for the circulation objective document data outputted from the output means; and
means for transmitting the approval result to the server,
wherein a plurality of circulation target persons are specifiable for one and the same circulation rank in the circulation route information.

27. A client program in accordance with claim 26, making the computer function as:
means for obtaining a change position of the circulation order of the circulation objective document data; and
means for notifying the change position of the circulation order to the server.

28. A client program for making a computer controlling a client terminal having a function to communicate information with a server connected via a network thereto function as:
means for obtaining circulation route information representing a circulation order of circulation objective document data as an object of circulation, by circulation target persons and circulation ranks;
means for transmitting the circulation objective document data and the circulation route information to the server;
means for transmitting a transmission request of the circulation objective document data to the server;
means for receiving the circulation objective document data from the server;
means for outputting therefrom the circulation objective document data received from the server;
means for obtaining an approval result for the circulation objective document data outputted from the output means;
means for transmitting the approval result to the server;
means for obtaining a change position of the circulation order of the circulation objective document data; and
means for notifying the change position of the circulation order to the server.

29. A client program in accordance with claim 28, wherein a plurality of circulation target persons are specifiable for one and the same circulation rank in the circulation route information.

30. A client program in accordance with claim 26, the program making the computer function as:
means for obtaining as circulation scheduled document data from the server, circulation objective document data for which the user of the own terminal is designated as a circulation target person and the person waiting for her or his turn for circulation of the document data; and
means for outputting therefrom the circulation scheduled document data.

31. A client program in accordance with claim 30, the program making the computer function as:
means for obtaining an approval result for the circulation scheduled document data; and
means for transmitting the approval result to the server.

32. A server program for making a computer controlling a server connected via a network to at least one user client terminal function as:
circulation rule information storage means having stored therein at least one circulation rule information item indicating a rule to circulate document data;
means for obtaining, from the user client terminal, circulation route information representing a circulation order of circulation objective document data as an object of circulation, by circulation target persons and circulation ranks;
means for determining whether the circulation order represented by the circulation route information obtained from the user client terminal conforms with the rule indicated by the circulation rule information stored in the circulation rule information storage means; and
means for transmitting, in response to a request from the user client terminal, the circulation objective document data of which the circulation order is determined to conform with the circulation rule information,
wherein a plurality of circulation target persons are specifiable for one and the same circulation rank in the circulation route information.

33. A server program in accordance with claim 32, the program making the computer function as:
means for obtaining a change position of the circulation order of the circulation objective document data from each of the user client terminals;
means for obtaining a circulation status of the circulation objective document data for which the change position of the circulation order is obtained from the user client terminal;
means for determining whether the change position of the circulation order obtained from the user client terminal changes a circulation target person for whom the circulation objective document data has not been circulated;
means for determining whether a circulation order after a change of the change position of the circulation order conforms with the rule indicated by the circulation rule information; and
means for allowing the change of the circulation order if the change position of the circulation order changes a circulation target person for whom the circulation objective document data has not been circulated and the change of the change position conforms with the rule indicated by the circulation rule information.

34. A server program for making a computer controlling a server connected via a network to at least one user client terminal function as:
circulation rule information storage means having stored therein at least one circulation rule information item indicating a rule to circulate document data;
means for obtaining, from the user client terminal, circulation route information representing a circulation order of circulation objective document data as an object of circulation, by circulation target persons and circulation ranks;
means for determining whether the circulation order represented by the circulation route information obtained from the user client terminal conforms with the rule indicated by the circulation rule information stored in the circulation rule information storage means;
means for transmitting, in response to a request from the user client terminal, the circulation objective document data of which the circulation order is determined to conform with the circulation rule information;
means for obtaining a circulation status of the circulation objective document data for which the change position of the circulation,order is notified from the user client terminal;
means for determining whether the change position of the circulation order notified from the user client terminal changes a circulation target person for whom the circulation objective document data has not been circulated;
means for determining whether a circulation order after a change of the change position of the circulation order conforms with the rule indicated by the circulation rule information; and,
means for allowing the change of the circulation order if the change position of the circulation order changes a circulation target person for whom the circulation objective document data has not been circulated and the change of the change position conforms with the rule indicated by the circulation rule information.

35. A server program in accordance with claim 34, wherein a plurality of circulation target persons are specifiable for one and the same circulation rank in the circulation route information.

36. A server program in accordance with claim 32, the program making the computer function as means for conducting notification after the circulation of the circulation objective document data is completely conducted by a circulation target person of a particular circulation rank, if the circulation has not been completely conducted for a circulation target person of a subsequent circulation rank during a predetermined period of time,
the notification notifying a lapse of the predetermined period of time to a circulation target person for whom the circulation objective document data has not been circulated.

37. A server program in accordance with claim 32, the program making the computer make a change after the circulation of the circulation objective document data is completely conducted by a circulation target person of a particular circulation rank, if the circulation has not been completely conducted for a circulation target person of a subsequent circulation rank during a predetermined period of time and if a proxy circulation target person is beforehand registered to the circulation objective document data,
the change changing the circulation order by setting the proxy circulation target person as a formal circulation target person.

38. A server program in accordance with claim 37, the program making the computer function as:
means for transmitting as circulation scheduled document data, in response to a request from the user client terminal, circulation objective document data for which the user of the user client terminal as a request source is designated as a circulation target person and the person waiting for her or his turn for circulation of the document data, to the user client terminal as a request source;
means for obtaining an approval result for the circulation scheduled document data from the user client terminal; and
means for confirming, at completion of the circulation by the circulation target person of a particular circulation rank, whether an approval result for the circulation scheduled document data by a circulation target person of a subsequent circulation rank has been registered, and assuming the approval result as an approval result of the circulation objective document data if the approval result has been registered.
